(19) United States
(12) Patent Application Publication
(10) Pub. No.: US 2025/0125934 A1
(43) Pub. Date: Apr. 17, 2025

(54) REDUCING OUT-OF-BAND EMISSION FOR TRANSMISSIONS ASSOCIATED WITH A DISTRIBUTED RESOURCE UNIT ALLOCATION

(71) Applicant: QUALCOMM Incorporated, San Diego, CA (US)

(72) Inventors: Lin YANG, San Diego, CA (US); Bin TIAN, San Diego, CA (US); Youhan KIM, Saratoga, CA (US); Qifan CHEN, Newark, CA (US); Chih-Yuan CHU, Hsinchu City (TW)

(21) Appl. No.: 18/603,011

(22) Filed: Mar. 12, 2024

Related U.S. Application Data
(60) Provisional application No. 63/590,337, filed on Oct. 13, 2023.

(51) Int. Cl. H04L 5/00; H04L 27/26

(52) U.S. Cl. CPC H04L 5/0073; H04L 5/0007; H04L 27/2613

(57) ABSTRACT

This disclosure provides methods, components, devices and systems for reducing out-of-band emission (OOBE) for transmissions associated with a distributed resource unit (RU) (dRU) allocation. Some aspects more specifically relate to introducing more unevenness in terms of tone spacing to a first subset of dRUs associated with a given bandwidth and maintaining relatively more even tone spacing for a second subset of dRUs associated with that given bandwidth. In some implementations, for example, a complete set of dRUs associated with a bandwidth may include a first subset of dRUs and a second subset of dRUs, with dRUs of the first subset having more uneven tone spacings as compared to dRUs of the second subset. In some aspects, the first subset of dRUs may include dRUs associated with relatively fewer tones as compared to dRUs of the second subset.

### CROSS REFERENCE

The present application for patent claims the benefit of U.S. Provisional Patent Application No. 63/590,337 by YANG et al., entitled “REDUCING OUT-OF-BAND EMISSION FOR TRANSMISSIONS ASSOCIATED WITH A DISTRIBUTED RESOURCE UNIT ALLOCATION,” filed Oct. 13, 2023, assigned to the assignee hereof, and expressly incorporated by reference herein.

### TECHNICAL FIELD

This disclosure relates to wireless communication and, more specifically, to reducing out-of-band emission (OOBE) for transmissions associated with a distributed resource unit (RU) (dRU) allocation.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

The systems, methods, and devices of this disclosure each have several innovative aspects, no single one of which is solely responsible for the desirable attributes disclosed herein.

One innovative aspect of the subject matter described in this disclosure can be implemented in an apparatus for wireless communication. The apparatus may include a processing system that includes processor circuitry and memory circuitry that stores code. The processing system may be configured to cause the apparatus to obtain an indication of a resource unit (RU) and an indication of a bandwidth, where a first subset of RUs associated with the bandwidth includes the indicated RU, the bandwidth being associated with the first subset and a second subset of RUs, where each of the RUs of the first subset includes a quantity of tones that is smaller than a quantity of tones of each of the RUs of the second subset, and where the indicated RU includes at least a first tone spacing between a first pair of consecutively populated tones, a second tone spacing between a second pair of consecutively populated tones, and a third tone spacing between a third pair of consecutively populated tones, and output a frame for transmission via the bandwidth and in accordance with the indicated RU.

Another innovative aspect of the subject matter described in this disclosure can be implemented in a method for wireless communication at a wireless node (such as a wireless station (STA)). The method may include obtaining an indication of an RU and an indication of a bandwidth, where a first subset of RUs associated with the bandwidth includes the indicated RU, the bandwidth being associated with the first subset and a second subset of RUs, where each of the RUs of the first subset includes a quantity of tones that is smaller than a quantity of tones of each of the RUs of the second subset, and where the indicated RU includes at least a first tone spacing between a first pair of consecutively populated tones, a second tone spacing between a second pair of consecutively populated tones, and a third tone spacing between a third pair of consecutively populated tones, and outputting a frame for transmission via the bandwidth and in accordance with the indicated RU.

Another innovative aspect of the subject matter described in this disclosure can be implemented in an apparatus for wireless communication. The apparatus may include means for obtaining an indication of an RU and an indication of a bandwidth, where a first subset of RUs associated with the bandwidth includes the indicated RU, the bandwidth being associated with the first subset and a second subset of RUs, where each of the RUs of the first subset includes a quantity of tones that is smaller than a quantity of tones of each of the RUs of the second subset, and where the indicated RU includes at least a first tone spacing between a first pair of consecutively populated tones, a second tone spacing between a second pair of consecutively populated tones, and a third tone spacing between a third pair of consecutively populated tones, and means for outputting a frame for transmission via the bandwidth and in accordance with the indicated RU.

Another innovative aspect of the subject matter described in this disclosure can be implemented in a non-transitory computer-readable medium storing code for wireless communication at an apparatus. The code may include instructions executable by one or more processors, individually or collectively, to cause the apparatus to obtain an indication of an RU and an indication of a bandwidth, where a first subset of RUs associated with the bandwidth includes the indicated RU, the bandwidth being associated with the first subset and a second subset of RUs, where each of the RUs of the first subset includes a quantity of tones that is smaller than a quantity of tones of each of the RUs of the second subset, and where the indicated RU includes at least a first tone spacing between a first pair of consecutively populated tones, a second tone spacing between a second pair of consecutively populated tones, and a third tone spacing between a third pair of consecutively populated tones and output a frame for transmission via the bandwidth and in accordance with the indicated RU.

Another innovative aspect of the subject matter described in this disclosure can be implemented in an apparatus for wireless communication. The apparatus may include a processing system that includes processor circuitry and memory circuitry that stores code. The processing system may be configured to cause the apparatus to output, for transmission, an indication of an RU and an indication of a bandwidth, where a first subset of RUs associate with the bandwidth includes the indicated RU, the bandwidth being associated with the first subset and a second subset of RUs, where each of the RUs of the first subset includes a quantity of tones that is smaller than a quantity of tones of each of the RUs of the second subset, and where the indicated RU includes at least a first tone spacing between a first pair of consecutively populated tones, a second tone spacing between a second pair of consecutively populated tones, and a third tone spacing between a third pair of consecutively populated tones, and obtain a frame via the bandwidth and in accordance with the indicated RU.

Another innovative aspect of the subject matter described in this disclosure can be implemented in a method for wireless communication at a wireless node (such as a wireless access point (AP)). The method may include outputting, for transmission, an indication of an RU and an indication of a bandwidth, where a first subset of RUs associated with the bandwidth includes the indicated RU, the bandwidth being associated with the first subset and a second subset of RUs, where each of the RUs of the first subset includes a quantity of tones that is smaller than a quantity of tones of each of the RUs of the second subset, and where the indicated RU includes at least a first tone spacing between a first pair of consecutively populated tones, a second tone spacing between a second pair of consecutively populated tones, and a third tone spacing between a third pair of consecutively populated tones, and obtaining a frame via the bandwidth and in accordance with the indicated RU.

Another innovative aspect of the subject matter described in this disclosure can be implemented in an apparatus for wireless communication. The apparatus may include means for outputting, for transmission, an indication of an RU and an indication of a bandwidth, where a first subset of RUs associated with the bandwidth includes the indicated RU, the bandwidth being associated with the first subset and a second subset of RUs, where each of the RUs of the first subset includes a quantity of tones that is smaller than a quantity of tones of each of the RUs of the second subset, and where the indicated RU includes at least a first tone spacing between a first pair of consecutively populated tones, a second tone spacing between a second pair of consecutively populated tones, and a third tone spacing between a third pair of consecutively populated tones, and means for obtaining a frame via the bandwidth and in accordance with the indicated RU.

Another innovative aspect of the subject matter described in this disclosure can be implemented in a non-transitory computer-readable medium storing code for wireless communication at an apparatus. The code may include instructions executable by one or more processors, individually or collectively, to cause the apparatus to output, for transmission, an indication of an RU and an indication of a bandwidth, where a first subset of RUs associate with the bandwidth includes the indicated RU, the bandwidth being associated with the first subset and a second subset of RUs, where each of the RUs of the first subset includes a quantity of tones that is smaller than a quantity of tones of each of the RUs of the second subset, and where the indicated RU includes at least a first tone spacing between a first pair of consecutively populated tones, a second tone spacing between a second pair of consecutively populated tones, and a third tone spacing between a third pair of consecutively populated tones, and obtain a frame via the bandwidth and in accordance with the indicated RU.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a frequency diagram depicting an example distributed tone mapping.

FIG. 5 shows an example signaling diagram that supports reducing out-of-band emission (OOBE) for transmissions associated with a distributed resource unit (RU) (dRU) allocation.

FIG. 6 shows an example tone exchange that supports reducing OOBE for transmissions associated with a dRU allocation.

FIG. 7 shows example dRU sets that support reducing OOBE for transmissions associated with a dRU allocation.

FIG. 8 shows an example dRU design for a 20 megahertz (MHz) bandwidth that supports reducing OOBE for transmissions associated with a dRU allocation.

FIG. 9 shows an example dRU design for a 40 MHz bandwidth that supports reducing OOBE for transmissions associated with a dRU allocation.

FIG. 10 shows an example dRU design for an 80 MHz bandwidth that supports reducing OOBE for transmissions associated with a dRU allocation.

FIG. 11 shows a block diagram of an example wireless communication device that supports reducing OOBE for transmissions associated with a dRU allocation.

FIGS. 12 and 13 show flowcharts illustrating example processes performable by or at a wireless node that supports reducing OOBE for transmissions associated with a dRU allocation.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IOT) network.

Various aspects relate generally to distributed transmission schemes, including transmissions of frames, packets, or messages in accordance with a distributed resource unit (RU) (dRU). Some aspects more specifically relate to introducing more unevenness in terms of tone spacing to a first subset of dRUs associated with a given bandwidth and maintaining relatively more even tone spacing for a second subset of dRUs associated with that given bandwidth. In some implementations, for example, a complete set of dRUs associated with a bandwidth (such as a 20 megahertz (MHz) bandwidth, a 40 MHz bandwidth, or an 80 MHz bandwidth, among other examples) may include a first subset of dRUs and a second subset of dRUs, with dRUs of the first subset having more uneven tone spacings as compared to dRUs of the second subset. In some aspects, the first subset of dRUs may include dRUs associated with relatively fewer tones as compared to dRUs of the second subset. For example, in scenarios in which a bandwidth is 20 MHz, the first subset of dRUs may include a dRU having 26 tones (such as one or more dRUs associated with a dRU type of dRU26) and a dRU having 52 tones (such as one or more dRUs associated with a dRU type of dRU52) and the second subset of dRUs may include a dRU having 106 tones (such as one or more dRUs associated with a dRU type of dRU106). In such aspects, the first subset of dRUs may be understood as a subset of relatively smallest or smaller dRUs associated with a given bandwidth and the second subset of dRUs may be understood as a subset of relatively largest or larger dRUs associated with that given bandwidth. As described herein, a “subset” may be understood as being less than a complete set, but non-empty (such that a subset includes at least one member).

In some implementations, each dRU of the first subset of dRUs may include at least three different tone spacings. For example, a dRU of the first subset of dRUs may include at least a first tone spacing between two tones of a first pair of consecutively populated tones of the dRU (such as a first pair of consecutively distributed tones of the dRU), a second tone spacing (different from the first tone spacing) between two tones of a second pair of consecutively populated tones of the dRU (such as a second pair of consecutively distributed tones of the dRU), and a third tone spacing (different from the first and second tone spacings) between two tones of a third pair of consecutively populated tones of the dRU (such as a third pair of consecutively distributed tones of the dRU). As described herein, a pair of “consecutively populated” or “consecutively distributed” tones may refer to two tones (such as subcarriers) via which a signal is transmitted and between which there are one or multiple other tones via which the signal is not transmitted. Such other tones may be understood as “unpopulated” or “empty” tones. In other words, a span of one or more tones between a pair of consecutively populated or consecutively distributed tones may exclude any other populated or distributed tone. Further, as described herein, a “populated” tone may be equivalently referred to herein as a “distributed” tone, an “occupied” tone, or a tone via which a signal is transmitted (such as a tone via which information is conveyed).

The dRUs of the first subset of dRUs may each include at least three different tone spacings by pre-configuration (such as in accordance with a network or communication standard), in accordance with a switch vector (which may be implemented by, as, or via an indicator or a bitmap), or in accordance with any other mechanism usable to diversify the tone spacings within a dRU. In implementations in which the dRUs of the first subset each include at least three different tone spacings by pre-configuration, the tone spacings of each of the dRUs of the first subset may be pre-configured (such as pre-loaded) in one or more memories of a wireless node and retrievable upon a signaled indication of a dRU of the first subset. Additionally, or alternatively, one or more wireless nodes may introduce tone spacing diversity (such that there are at least three different tone spacings) to a first dRU of the first subset by switching one or more first tones of the first dRU with one or more second tones of a second dRU (with the first dRU and the second dRU including a same quantity of tones) in accordance with a switch vector. For example, a switch vector may indicate, for each tone index, a first value to trigger a tone switch between the first dRU and the second dRU for that tone index or a second value to not trigger a tone switch between the first dRU and the second dRU for that tone index.

Particular aspects of the subject matter described in this disclosure can be implemented to realize one or more of the following potential advantages. In some examples, by introducing additional tone spacing diversity (such as to increase the quantity of different or unique tone spacings within a dRU) for relatively smaller dRUs associated with a given bandwidth, the described techniques can be used to reduce out-of-band emission (OOBE) for dRU transmissions and achieve at least a threshold amount of transmit power backoff reduction or transmit power gain. In some aspects, the threshold amount of transmit power backoff reduction may be, for example, greater than or equal to 1 decibel (dB) of transmit power backoff reduction, which may increase the transmit power and sufficiently offset any loss of channel smoothing that might result from introducing tone spacing diversity. Further, in accordance with some example implementations, relatively even and small tone spacing (such that there are no more than, for example, two or three different or unique tone spacings, and such that populated or distributed tones are relatively near each other, such as within a threshold quantity of tones) may be maintained for relatively larger dRUs associated with a given bandwidth to maintain channel smoothing support for such relatively larger dRUs. As such, the subject matter described in this disclosure can be implemented to balance OOBE reduction and channel smoothing support, which may maximize (or otherwise increase) the power gain through dRU transmission. In accordance with balancing OOBE and channel smoothing support, the described techniques may be further implemented to realize higher transmit power, longer range (as wireless nodes may communicate with each other at relatively greater distances due to being able to use relatively higher transmit powers), higher data rates, greater spectral efficiency, and greater system capacity, among other benefits.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

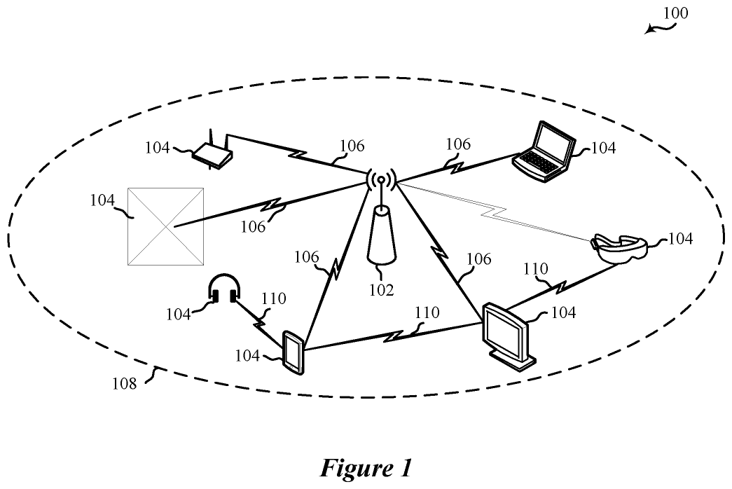

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (cNB), a gNB, a transmission reception point (TRP) or another type of device or equipment included in a radio access network (RAN), including Open-RAN (O-RAN) network entities, such as a central unit (CU), a distributed unit (DU) or a radio unit.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHZ-7.125 GHZ), FR2 (24.25 GHz-52.6 GHz), FR3 (7.125 GHz-24.25 GHZ), FR4a or FR4-1 (52.6 GHz-71 GHz), FR4 (52.6 GHz-114.25 GHZ), and FR5 (114.25 GHZ-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

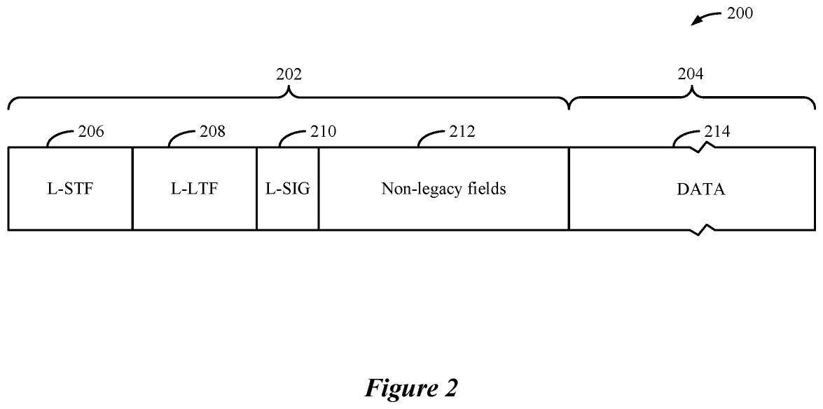

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

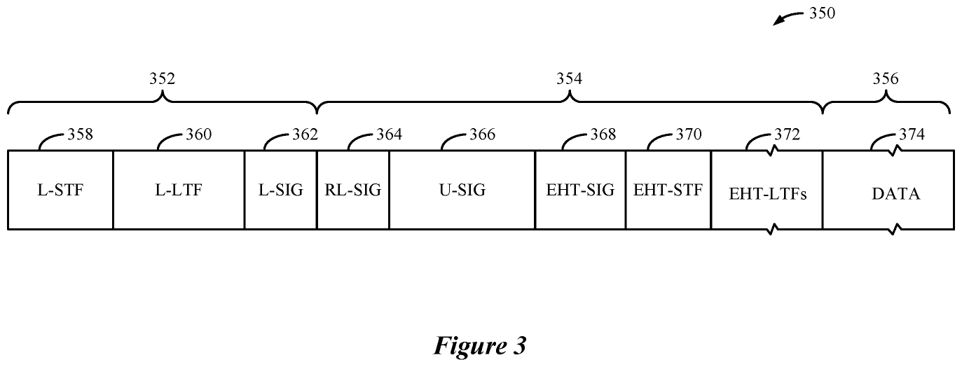

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field 366 (referred to herein as “U-SIG 366”) and an EHT signal field 368 (referred to herein as “EHT-SIG 368”). The presence of RL-SIG 364 and U-SIG 366 may indicate to EHT—or later version—compliant STAs 104 that the PPDU 350 is an EHT PPDU or a PPDU conforming to any later (post-EHT) version of a new wireless communication protocol conforming to a future IEEE 802.11 wireless communication protocol standard. One or both of U-SIG 366 and EHT-SIG 368 may be structured as, and carry version-dependent information for, other wireless communication protocol versions associated with amendments to the IEEE family of standards beyond EHT. For example, U-SIG 366 may be used by a receiving device (such as the AP 102 or the STA 104) to interpret bits in one or more of EHT-SIG 368 or the data field 374. Like L-STF 358, L-LTF 360, and L-SIG 362, the information in U-SIG 366 and EHT-SIG 368 may be duplicated and transmitted in each of the component 20 MHz channels in instances involving the use of a bonded channel.

The non-legacy portion 354 further includes an additional short training field 370 (referred to herein as “EHT-STF 370,” although it may be structured as, and carry version-dependent information for, other wireless communication protocol versions beyond EHT) and one or more additional long training fields 372 (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

EHT-SIG 368 may be used by an AP 102 to identify and inform one or multiple STAs 104 that the AP 102 has scheduled uplink (UL) or downlink (DL) resources for them. EHT-SIG 368 may be decoded by each compatible STA 104 served by the AP 102. EHT-SIG 368 may generally be used by the receiving device to interpret bits in the data field 374. For example, EHT-SIG 368 may include RU allocation information, spatial stream configuration information, and per-user (such as STA-specific) signaling information. Each EHT-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some environments, locations, or conditions, a regulatory body may impose a power spectral density (PSD) limit for one or more communication channels or for an entire band (such as the 6 GHz band). A PSD is a measure of transmit power as a function of a unit bandwidth (such as per 1 MHZ). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some examples in which transmissions are subject to a PSD limit, the AP 102 or the STAs 104 of the wireless communication network 100 may transmit over a greater transmission bandwidth to allow for an increase in the total transmit power, which may increase a signal-to-noise ratio (SNR) and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (such as duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a set of tones or subcarriers (and, in some aspects, also a quantity of tones or subcarriers, such as in accordance with an RU26 representing or otherwise referring to a quantity of 26 tones) that are allocated to a given STA 104 for transmission of a PPDU. As used herein, the term “regular RU” (or rRU) refers to any RU or multiple RU (MRU) tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. Further, the terms “tone” and “subcarrier” may be used herein interchangeably. The channel or portion of a channel within which the distributed tones are interspersed is referred to as a spreading bandwidth, which may be, for example, 40 MHz, 80 MHz or more. The use of dRUs may be limited to uplink communications because benefits to addressing PSD limits may only be present for uplink communications.

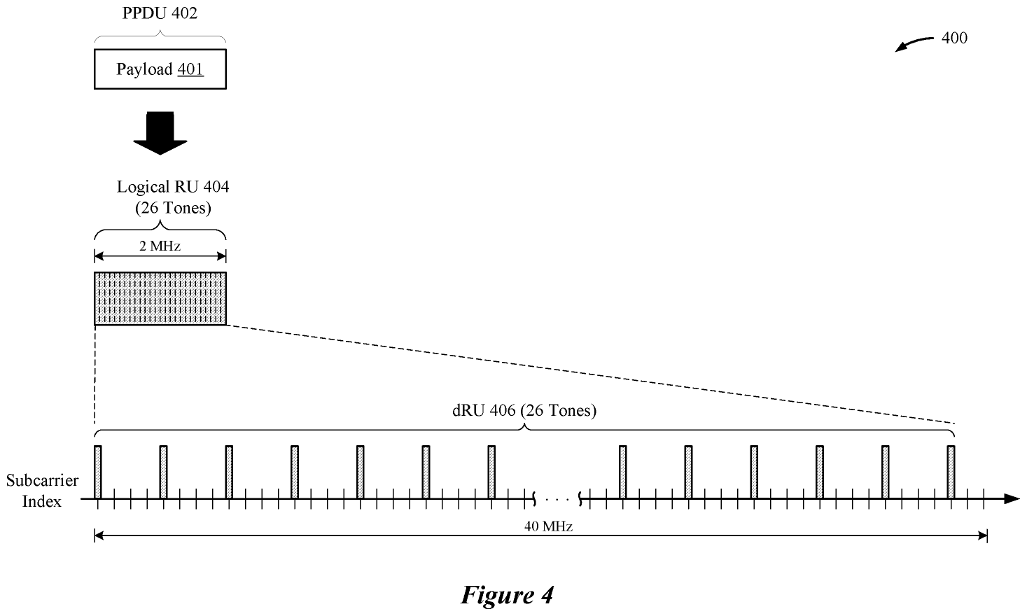

FIG. 4 shows a frequency diagram 400 depicting an example distributed tone mapping. More specifically, FIG. 4 shows an example mapping of how the tones of a payload 401 of a PPDU 402 are distributed for transmission over a spreading bandwidth of a wireless channel. In the illustrated example, the tones in a logical RU 404 (which may represent an rRU of non-distributed tones in accordance with a legacy tone plan) associated with payload 401 are mapped to a dRU 406 in accordance with a distributed tone plan.

Aspects of the present disclosure recognize that by distributing the tones across a wider bandwidth, the per-tone transmit power of a logical RU 404 may be increased to provide greater flexibility in medium utilization for PSD-limited wireless channels. For example, when mapped to an rRU such as logical RU 404, the transmit power of the logical RU 404 may be severely limited based on the PSD of the wireless channel. For example, the LPI power class limits the transmit power of APs 102 and STAs 104 to 5 dBm/MHz and −1 dBm/MHz, respectively, in the 6 GHz band. As such, the per-tone transmit power of the logical RU 404 is limited by the number of tones mapped to each 1 MHz subchannel of the wireless channel.

By enabling a STA 104 to map modulation symbols in a distributed manner onto noncontiguous tones interspersed throughout all or a portion of a wireless channel, distributed transmissions may enable an increase in the per-tone transmit power used for each individual distributed tone, and thus the overall transmit power of the PPDU, without exceeding the PSD limits of the wireless channel. As shown in the example of FIG. 4, STA 104 may map logical RU 404 to a set of 26 noncontiguous subcarrier indices spread across a 40 MHz wireless channel (also referred to herein as an exemplary “spreading bandwidth”). Compared to the tone mapping described above with respect to the legacy tone plan, the distributed tone mapping depicted in FIG. 4 effectively reduces the number of tones (of the logical RU 404) in each 1 MHZ subchannel. For example, each of the 26 tones can be mapped to a different 1 MHZ subchannel of the 40 MHz channel. As a result, each AP 102 or STA 104 implementing the distributed tone mapping of FIG. 4 can maximize its per-tone transmit power (which may maximize the overall transmit power of the logical RU 404).

In some examples (not shown in FIG. 4), multiple logical RUs may be mapped to interleaved subcarrier indices of a shared wireless channel. For example, STA 104 may modulate a portion of the symbols on a number of tones representing multiple logical RUs to noncontiguous subcarrier indices associated with a shared wireless channel in accordance with a distributed tone plan. Furthermore, distributed transmissions by multiple STAs 104 may be multiplexed onto different sets of distributed tones of a shared wireless channel such as to enable an increase in the transmit power of each device without sacrificing spectral efficiency. Such increases in transmit power can be combined with some MCSs to increase the range and throughput of wireless communications on PSD-limited wireless channels. Distributed transmissions also may improve packet detection and channel estimation capabilities.

To support distributed transmissions, new packet designs and signaling are needed to indicate whether a PPDU 402 is transmitted on tones spanning a logical RU 404 (according to a legacy tone plan) or a dRU 406 (according to a distributed tone plan). For example, the IEEE 802.11be standard amendment or earlier versions of the IEEE 802.11 family of wireless communication protocol standards define a trigger frame format which can be used to solicit the transmission of a trigger-based (TB) PPDU from one or more STAs 104. The trigger frame allocates resources to the STAs 104 for the transmission of the TB PPDU and indicates how the TB PPDU is to be configured for transmission. For example, the trigger frame may indicate a logical RU or MRU allocated for transmission in the TB PDDU. In some examples, the trigger frame may be further configured to carry tone distribution information indicating whether the logical RU (or MRU) maps to a logical RU 404 or a dRU 406.

In some implementations, a STA 104 may include a distributed tone mapper that maps the logical RU 404 to the dRU 406 in the frequency domain. The dRU 406 is converted to a time-domain signal (such as by an inverse fast Fourier transform) for transmission over a wireless channel. The AP 102 may receive the time-domain signal and reconstruct the dRU 406 (such as by a fast Fourier transform). In some implementations, the AP 102 may include a distributed tone demapper that demaps the dRU 406 to the logical RU 404. In other words, the distributed tone demapper reverses the mapping performed by the distributed tone mapper at the STA 104. The AP 102 can recover the information carried (or modulated) on the logical RU 404 as a result of the demapping.

In the example of FIG. 4, the logical RU 404 is distributed evenly across the spreading bandwidth. While the example shown in FIG. 4 illustrates a spreading bandwidth of 40 MHz, spreading bandwidths also may include 80 MHz, 160 MHz, or 320 MHz. In some implementations, the logical RU 404 can be mapped to any suitable pattern of noncontiguous subcarrier indices. For example, in various implementations, the distance between any pair of adjacent modulated tones may be less than or greater than the distances depicted in FIG. 4.

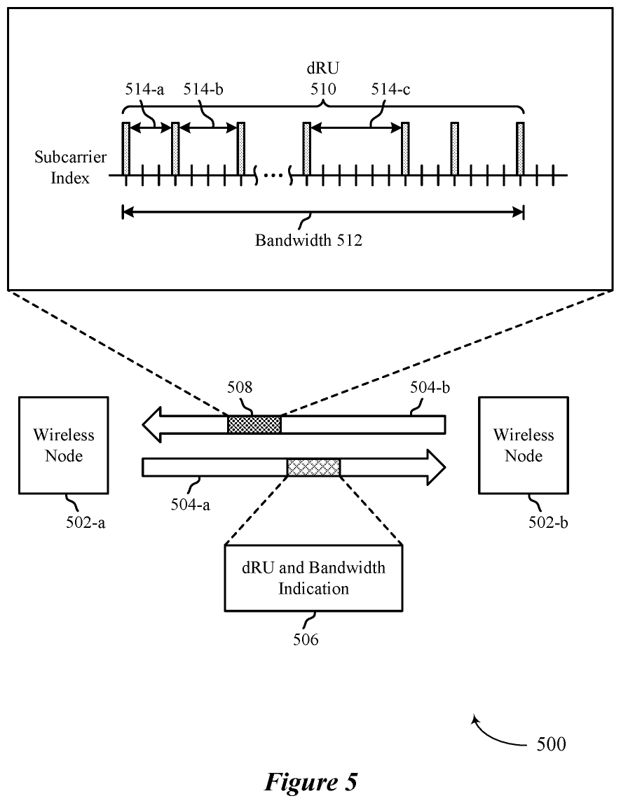

FIG. 5 shows an example signaling diagram 500 that supports reducing OOBE for transmissions associated with a dRU. The signaling diagram 500 may implement or be implemented to realize aspects of the wireless communication network 100, the PDU 200, the PPDU 350, and the frequency diagram 400. For example, the signaling diagram 500 illustrates communication between a wireless node 502-a and a wireless node 502-b, which may be examples of wireless communication devices described herein. For example, the wireless node 502-a may be an AP 102 or a STA 104, and the wireless node 502-b may be an AP 102 or a STA 104. In some examples, the wireless node 502-a and the wireless node 502-b may communicate in accordance with a distributed communication scheme according to which the wireless node 502-a and the wireless node 502-b may communicate (such as transmit or receive, or both) in accordance with (such as using or via) one or more dRUs.

In some deployments, distributed transmissions (such as a transmission of a frame, packet, or message via or in accordance with a dRU) may be associated with similar or slightly larger transmit power backoffs than a regular full bandwidth transmission (such as a transmission of a frame, packet, or message via or in accordance with an rRU) due to wide bandwidth from dRU spreading. As described herein, a “regular” or “full bandwidth” transmission may be understood as a transmission via a set of contiguous or non-distributed tones (such as subcarriers). For regular transmissions, an expected transmit power backoff may increase with RU size, such that a largest transmit power backoff corresponds to a full bandwidth transmission. In other words, an expected transmit power backoff for an RU (such as an rRU) having 26 tones may generally be lower than an expected transmit power backoff for an RU (such as an rRU) having 52 tones, and so on.

For distributed transmissions, an expected transmit power backoff may increase with an evenness of the distributed dRUs, rather than with RU size, as relatively more even tone distributions may result in (such as cause) more accumulation of harmonics that generate local peaks in OOBE. In other words, dRUs associated with relatively more even tone spacings may be associated with a relatively larger OOBE and, likewise, a larger transmit power backoff. For example, a first dRU including an even tone spacing (such that tones of each pair of consecutively populated or distributed tones are separated by a constant, same quantity of unpopulated tones) may be associated with a relatively higher transmit power backoff than a second dRU including an uneven tone spacing (such that tones of some pairs of consecutively populated or distributed tones are separated by different quantities of unpopulated tones). For further example, and more generally, a first dRU including a first quantity (1, 2, 3, 4, or any other quantity) of different tone spacings may be associated with a first transmit power backoff and a second dRU including a second quantity (1, 2, 3, 4, or any other quantity) of different tone spacings may be associated with a second transmit power backoff, with the first transmit power backoff being greater than the second transmit power backoff if the first quantity of different tone spacings is less than the second quantity of different tone spacings.

In other words, relatively fewer different (such as unique) tone spacings may be associated with or correspond to a relatively more even tone spacing. As described herein, a quantity of different or unique tone spacings may refer to how many distinct tone spacings are present within a dRU. For example, a dRU associated with tone spacings of “3, 4, 3, 4 . . . ” may be associated with two different or unique tone spacings (namely, 3 and 4). For further example, a dRU associated with tone spacings of “4, 6, 8, 4, 6, 8 . . . ” may be associated with three different or unique tone spacings (namely, 4, 6, and 8). A dRU associated with two different or unique tone spacings may be understood as having a relatively more even tone spacing than a dRU associated with three different or unique tone spacings.

Accordingly, breaking an evenness of a distributed tone mapping (such as by introducing additional diversity in tone spacings) may reduce an expected transmit power backoff associated with a given dRU (such that a relatively higher transmit power may be used). In other words, breaking an evenness of a distributed tone mapping may offer transmit power gain. Evenness in a distributed tone mapping may accommodate channel smoothing, although, in some implementations, any potential loss in channel smoothing caused by breaking the evenness may be compensated by LTF repetition. Accordingly, in accordance with some implementations of the present disclosure, the wireless node 502-a and the wireless node 502-b may reduce OOBE for dRU allocations by breaking even tone mappings, such as by introducing additional diversity in terms of how many different (such as unique) tone spacings are included within a given dRU, and selectively including additional repetitions of an LTF (such as an L-LTF 208, an L-LTF 360, or an EHT-LTF 372).

In some implementations, relatively less transmit power gain may be achieved in relatively larger dRUs by introducing additional diversity in tone spacings (such as by tone adjustment) and greater channel smoothing gain may be obtained from even distributions of tones with small spacings. For a large dRU (such as a dRU including a relatively large quantity of tones, such as greater than a threshold quantity of tones), tone spacing may be small and mostly even, channel smoothing may be possible, and a wireless node may select to keep the smoothing property. On the other hand, for a small dRU (such as a dRU including a relatively small quantity of tones, such as less than a threshold quantity of tones), tone spacing may become larger as a quantity of tones decreases, channel smoothing may not be realistic, and a wireless node may select to adjust the tones to remove evenness. Aspects of the present disclosure may be implemented to adjust tones (such as to introduce additional diversity in tone spacings) for relatively smaller dRUs for OOBE reduction and maintain relatively more even tone distributions for relatively larger dRUs. Further, in accordance with the described techniques, tones of relatively smaller dRUs may be adjusted (to diversify the tone spacings in those dRUs) without impacting the tones of relatively larger dRUs, considering that both a tone plan and a tone mapping follow a hierarchical structure (as relatively smaller dRUs are used to build, create, or make relatively larger dRUs). In other words, some example tone exchanges of the present disclosure may introduce tone spacing diversity for some (relatively smaller) dRUs while preserving the hierarchical tone mapping structure and preserving channel smoothing support (for at least relatively larger dRUs).

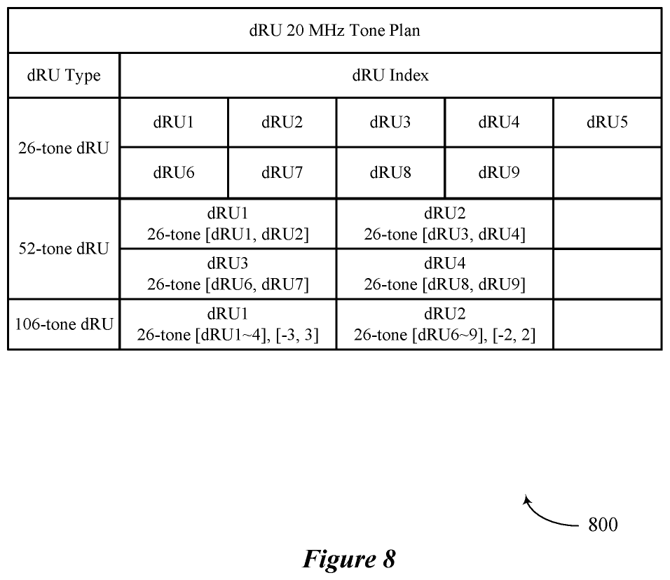

For example, in the example of a bandwidth of 20 MHz, a dRU52_1=[dRU26_1 dRU26_2] (such that the dRU52_1 includes, or is made up by, a dRU26_1 and a dRU26_2) and a dRU106_1=[dRU52_1 dRU52_2]+extra tones (such that the dRU106_1 includes, or is made up by, the dRU52_1, a 1 dRU52_2, and a quantity of extra tones). The dRU106_1 may alternatively be understood such that the dRU106_1=[dRU26_1 dRU26_2 dRU26_3 dRU26_4]+extra tones. In other words, the dRU106_1 may include, or be made up by, four dRU26s and a quantity of extra tones. Such a manner of relatively larger dRUs including multiple of the relatively smaller dRUs for a given bandwidth may be representative of the hierarchical structure, which is further illustrated by and described with reference to FIGS. 8-10.

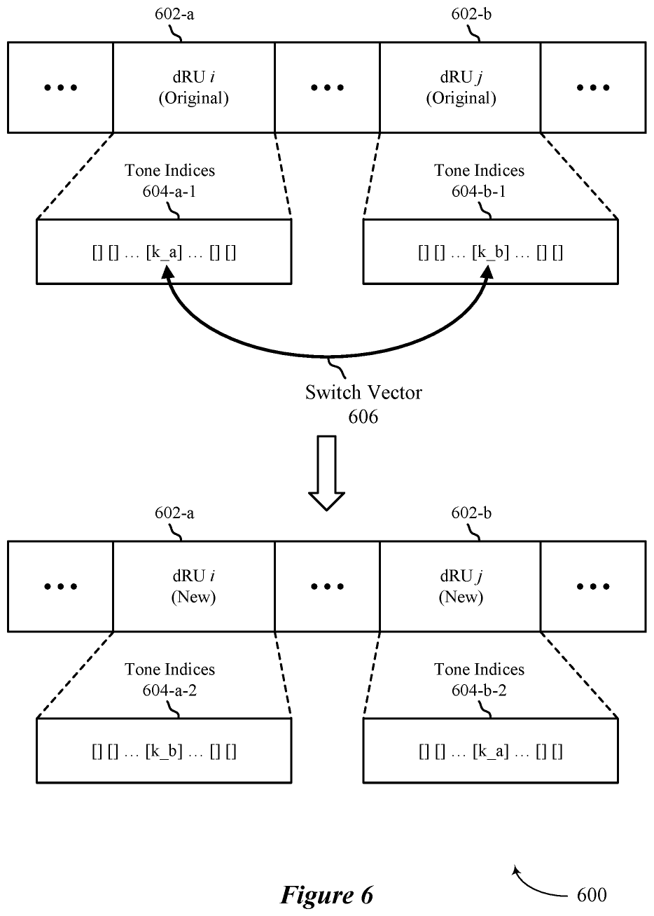

In the example of a bandwidth of 20 MHz, within each period of 9 tones (which may be a baseline or example tone spacing for dRU26 in some systems), exchanging tones between the dRU26_1 and the dRU26_2 may not change (such as not impact) a dRU52 tone plan (such as the dRU52_1). Further, exchanging tones among the dRU26_1, the dRU26_2, the dRU26_3, and the dRU26_4 may not change (such as not impact) a dRU106 tone plan (such as the dRU106_1). As such, to maintain the tone plan for the dRU106_1 while changing tones within the under-covered dRU52 and dRU26, the wireless node 502-a and the wireless node 502-b may randomly (or in accordance with a network standard or in accordance with a switch vector) exchange tones between dRU26_1 & (dRU26_3, dRU26_4), or between dRU26_2 & (dRU26_3, dRU26_4), or between dRU26_3 & (dRU26_1, dRU26_2), or between dRU26_4 & (dRU26_1, dRU26_2). Additional details relating to tone exchange (such as tone switching) are illustrated by and described with reference to FIG. 6.

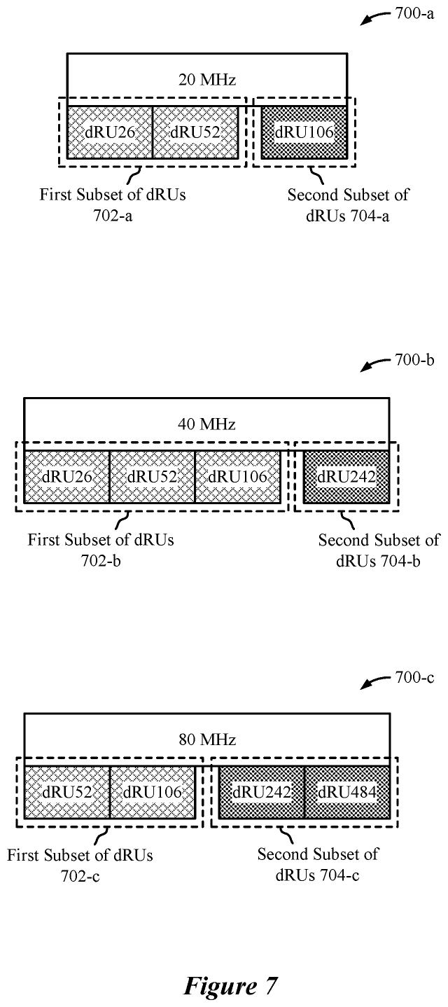

In accordance with a tone exchange or some other manner of diversifying the tone spacings present within some dRUs, the wireless node 502-a and the wireless node 502-b may support tone plans according to which, for a given bandwidth, a first subset of dRUs include relatively more uneven tone spacings and a second subset of dRUs include relatively more even and small tone spacings (where “small” tone spacings may refer to how populated or distributed tones may be relatively close to each other, such as within a threshold quantity of tones/subcarrier indices). The first subset of dRUs may be understood as being associated with that given bandwidth in accordance with the first subset of dRUs being available for use (such as for a transmission) at that given bandwidth. In other words, a dRU (or a subset or set of dRUs) associated with a bandwidth may be a dRU (or a subset or set of dRUs) within the bandwidth. In some aspects, dRUs of the first subset may include relatively fewer tones than dRUs of the second subset, as illustrated by and described in more detail with reference to FIG. 7. In some aspects, each dRU of the first subset may include (or otherwise be associated with) at least three or at least four different tone spacings. In some aspects, each dRU of the second subset may include (or otherwise be associated with) at most three different tone spacings. As such, generally, the first subset of dRUs may include relatively smaller dRUs with relatively more uneven tone spacings as compared to the dRUs of the second subset of dRUs. The dRUs of the first subset may have relatively more variations of tone spacing for OOBE control (such as to reduce a transmit power backoff associated with a dRU transmission).

Accordingly, the wireless node 502-a (a scheduling node) may transmit a dRU and bandwidth indication 506 to the wireless node 502-b via a communication link 504-a and the dRU and bandwidth indication 506 may convey an indication of a dRU 510 and a bandwidth 512. The communication link 504-a may be understood as a downlink, an uplink, a peer link, a forward link, or a reverse link. In some aspects, the wireless node 502-a may transmit the dRU and bandwidth indication 506 via a trigger frame, such as an uplink Trigger frame, a transmission opportunity (TXOP) sharing (TXS) frame, a request-to-send (RTS) frame, an RTS TXS frame, or any combination thereof. Additionally, or alternatively, the wireless node 502-a may transmit the dRU and bandwidth indication 506 via any other PPDU, message, packet, or frame. Thus, an indication of the dRU 510 and the bandwidth 512 may be a frame, PPDU, message, or packet. Further, the indication of the dRU 510 and the bandwidth 512 may include or be one or more fields, or information provided via one or more fields. The indication of the dRU 510 and the bandwidth 512 may include two indications, such as a first indication (such as a first field, a first set of bits, or a first frame) providing information indicative of the dRU 510 and a second indication (such as a second field, a second set of bits, or a second frame) providing information indicative of the bandwidth 512.

In some implementations, the first subset of dRUs may include the indicated dRU 510, such that the indicated dRU 510 may include at least three or at least four different tone spacings. For example, the dRU 510 may include at least a first tone spacing 514-a between two tones of a first pair of consecutively populated or distributed tones of the dRU 510, a second tone spacing 514-b between two tones of a second pair of consecutively populated or distributed tones of the dRU 510, and a third tone spacing 514-c between two tones of a third pair of consecutively populated or distributed tones of the dRU 510. Each of the first tone spacing 514-a, the tone spacing 514-b, and the tone spacing 514-c may be different, such that each refers to a different quantity of tones between consecutively populated or distributed tones of the dRU 510. Further, consecutively populated or distributed tones of the dRU 510 may be separated by a quantity of unpopulated or empty tones, such that consecutively populated or distributed tones of the dRU 510 may not be understood as being contiguous tones.

The wireless node 502-b may transmit a frame 508 via the bandwidth 512 and in accordance with the indicated dRU 510. The wireless node 502-b may transmit the frame 508 in accordance with the dRU 510 by transmitting the frame 508 via, using, or within the dRU 510 (and/or in accordance with transmitting the frame 508 using a transmit power associated with (such as enabled by) use of the dRU 510). The wireless node 502-b may transmit the frame 508 to the wireless node 502-a via a communication link 504-b. The communication link 504-b may be understood as a downlink, an uplink, a peer link, a forward link, or a reverse link. The frame 508 may be an example of or may otherwise be referred to as a PPDU, a data frame, a data packet, a data message, a data payload, or any combination thereof. In some implementations, the wireless node 502-b may set a power backoff parameter (such as a transmit power backoff parameter) to a value in accordance with the indicated dRU 510 and may transmit the frame 508 based on the power backoff parameter. For example, in accordance with the dRU 510 including at least three or at least four different tone spacings, the wireless node 502-b may set the power backoff parameter to a relatively lower value than the wireless node 502-b might otherwise use for a dRU including relatively more even tone spacings. Thus, the wireless node 502-b may transmit via (such as on, using, or otherwise in accordance with) the dRU 510 using a relatively higher transmit power, which may increase coverage, provide a greater SNR, and increase the likelihood for successful communication (by way of, for example, providing a greater SNR or increased coverage), which may in turn increase spectral efficiency and reduce power consumption by way of reducing the likelihood of retransmissions.

The wireless node 502-a may receive the frame 508 via the bandwidth 512 and in accordance with the indicated dRU 510 and, in some implementations, may refrain from applying, employing, using, or otherwise leveraging a channel smoothing scheme as part of receiving and decoding the frame 508. In some aspects, the wireless node 502-a may refrain from applying the channel smoothing scheme in accordance with the indicated dRU 510 including at least three or at least four different tone spacings. For example, each of the dRUs of the first subset of dRUs may be independent of a channel smoothing scheme in accordance with the dRUs of the first subset of dRUs being relatively uneven in terms of tone spacing. This may differ from dRUs of the second subset of dRUs, which may be relatively even and small in terms of tone spacing. As such, the wireless node 502-a may apply a channel smoothing scheme as part of receiving a frame from the wireless node 502-b that is transmitted in accordance with a dRU of the second subset of dRUs.

In some implementations, the wireless node 502-a may refrain from performing an action (such as applying a channel smoothing scheme) for a time period (such as for at least a time period). Such a time period may refer to an operational lifetime of the wireless node 502-a (such that the wireless node 502-a always refrains from applying the channel smoothing scheme for the indicated dRU 510 including at least three or at least four different tone spacings), a time period of an operation mode (such that the wireless node 502-a refrains from applying the channel smoothing scheme for the indicated dRU 510 including at least three or at least four different tone spacings when operating in accordance with the operation mode), or any discrete time period (such as a quantity of any unit of time such as seconds, milliseconds, or microseconds). Outside of such a time period, the wireless node 502-a may perform the action (instead of refraining from performing the action). The wireless node 502-a may receive an indication of the time period or may retrieve information indicative of the time period from at least one memory of the wireless node 502-a.

Further, although illustrated and described in the context of the wireless node 502-a scheduling a transmission by the wireless node 502-b and indicating the dRU 510 and the bandwidth 512 for the transmission by the wireless node 502-b, the wireless node 502-b may alternatively, or additionally, indicate the dRU 510 and the bandwidth 512 via the frame 508 or otherwise in connection with transmitting the frame 508. For example, the wireless node 502-b may indicate the dRU 510 and the bandwidth 512 via a preamble of the frame 508, such as via one or more fields of a preamble of the frame 508, with or without receiving the dRU and bandwidth indication 506 from the wireless node 502-a. Further, in some aspects, the wireless node 502-a may provide (such as transmit) the dRU and bandwidth indication 506 to the wireless node 502-b and the wireless node 502-b may transmit the frame 508 to another wireless device (not shown).

FIG. 6 shows an example tone exchange 600 that supports reducing OOBE for transmissions associated with a dRU allocation. The tone exchange 600 may be implemented to realize aspects of the signaling diagram 500. For example, a wireless node, such as either or both of the wireless node 502-a or the wireless node 502-b, may perform operations associated with the tone exchange 600 to introduce additional diversity in tone spacings for one or more dRUs, which may enable the wireless node to reduce (such as lower) a transmit power backoff value. In other words, a wireless node may set a transmit power backoff parameter to a relatively lower value when (as part of) performing a dRU transmission of a relatively smaller dRU having relatively more uneven tone spacing, as compared to a relatively higher value that the wireless node may use when (as part of) performing a dRU transmission of a dRU having relatively more even tone spacing. In some aspects, a wireless node may perform the tone exchange 600 between interleaved subcarriers of different RUs.

In some implementations, a wireless node may perform the operations associated with the tone exchange 600 to switch (such as exchange) tones between two different dRUs of a same dRU type (such as between dRUs having a same size, such as having a same quantity of tones). In the context of the example tone exchange 600 illustrated by FIG. 6, a wireless node may exchange tones between a dRU 602-a and a dRU 602-b. The dRU 602-a may be alternatively referred to as a dRU_i (such as, for a given dRU type, a dRU of index i). The dRU 602-b may be alternatively referred to as a dRU_j (such as, for that given dRU type, a dRU of index j). In some aspects, the first subset of (relatively smaller) dRUs may include both the dRU 602-a and the dRU 602-b, each of the dRU 602-a and the dRU 602-b may have a same quantity of tones (such that both are associated with a dRU type of dRU26, or such that both are associated with a dRU type of dRU52, or such that both are associated with a dRU type of dRU106, and so on). The wireless node may perform the operations associated with the tone exchange 600 to introduce additional diversity in tone spacings for the dRU 602-a and the dRU 602-b.

For example, the dRU 602-a (such as an original version of the dRU 602-a) may include a set of tone indices 604-a-1 and the dRU 602-b (such as an original version of the dRU 602-b) may include a set of tone indices 604-b-1 and the wireless node may use a switch vector 606 to introduce additional diversity in tone spacings for the dRU 602-a and the dRU 602-b. The wireless node may apply the switch vector 606 on a per-tone (such as on a tone-by-tone) basis. For example, for a k^{th} tone in the dRU 602-a (such as a tone k_a as illustrated in the example of FIG. 6), a tone exchange pair of the k^{th} tone of the dRU 602-a and the k^{th} tone of the dRU 602-b may perform a tone exchange based on the switch vector 606. In other words, for a k^{th} tone in the dRU 602-a, a wireless node may selectively switch the k^{th} tone of the dRU 602-a with the k^{th} tone of the dRU 602-b in accordance with (such as in accordance with an output of or indication from) the switch vector 606.

In some aspects, the switch vector 606 may be understood or denoted as a switch vector Vᵢⱼ (such as to denote a switching between a dRU_i and a dRU_j). In some aspects, the switch vector notation may further reference a tone index (at which switching or no switching is to occur) and may indicate a first value to indicate switching of tones between the dRU 602-a and the dRU 602-b or a second value to indicate no switching of tones between the dRU 602-a and the dRU 602-b. The switch vector 606 may also be referred to as a bitmap or an indicator. For example, if Vᵢⱼ(k)=0 (or any first value), no switching (such as no tone exchange) is expected to occur between the dRU 602-a and the dRU 602-b at tone index k. Such a lack of switching or lack of tone exchange may be expressed by Equations 1 and 2.

$$dRU {i}_{n e w} ( k ) = dRU {i}_{original} ( k ) \qquad ( 1 )$$

$$dRU {j}_{n e w} ( k ) = dRU {j}_{original} ( k ) \qquad ( 2 )$$

In the example of a dRU26, the lack of switching may be expressed more specifically by Equations 3 and 4. Similar notation may be used for dRU52s, dRU106s, and so on.

$$dRU 26 {\_i}_{new} ( k ) = dRU 26 {\_i}_{o riginal} ( k ) \qquad ( 3 )$$

$$dRU 26 {\_j}_{new} ( k ) = dRU 26 {\_j}_{o riginal} ( k ) \qquad ( 4 )$$

For further example, and as illustrated in the example of FIG. 6, if Vᵢⱼ(k)=1 (or any second value different from the first value), switching (such as a tone exchange) may be expected to occur between the dRU 602-a and the dRU 602-b at tone index k. Such switching or tone exchange may be expressed by Equations 5 and 6. In the example illustrated by FIG. 6, if Vᵢⱼ(k)=1, the new dRU 602-a may include tone indices 604-a-2 including a tone k_b (previously included in the original dRU 602-b) and the new dRU 602-b may include tone indices 604-b-2 including a tone k_a (previously included in the original dRU 602-a).

$$dRU {i}_{new} ( k ) = dRU {j}_{original} ( k ) \qquad ( 5 )$$

$$dRU {j}_{new} ( k ) = dRU {i}_{original} ( k ) \qquad ( 6 )$$

In the example of a dRU26, the switching or tone exchange may be expressed more specifically by Equations 7 and 8. Similar notation may be used for dRU52s, dRU106s, and so on.

$$dRU 26 {\_i}_{new} ( k ) = dRU 26 {\_j}_{original} ( k ) \qquad ( 7 )$$

$$dRU 26 {\_j}_{new} ( k ) = dRU 26 {\_i}_{original} ( k ) \qquad ( 8 )$$

In such examples, the switch vector 606 may be a bitmap of zero values (or any first value) and one values (or any second value different from the first value). For example, for any dRU_i and dRU_j each of 26 tones, a first example switch vector 606 may be denoted as a bitmap of Vᵢⱼ=[1, 1, 0, 1, 1, 0, 0, 1, 0, 1, 0, 1, 1, 1, 1, 1, 0, 1, 1, 0, 0, 1, 1, 0, 1, 0]. For further example, a second example switch vector 606 may be denoted as a bitmap of Vᵢⱼ=[1, 0, 0, 0, 0, 0, 1, 0, 0, 1, 1, 1, 0, 1, 1, 1, 1, 0, 1, 0, 1, 1, 0, 0, 0, 1]. Other example bitmap representations of switch vectors 606 include Vᵢⱼ=[0, 1, 1, 0, 1, 0, 1, 0, 0, 1, 0, 1, 0, 1, 0, 0, 1, 1, 0, 0, 0, 0, 0, 1, 0, 0], Vᵢⱼ=[0, 0, 1, 1, 0, 1, 1, 1, 0, 1, 1, 1, 1, 0, 0, 0, 0, 1, 1, 1, 0, 1, 1, 1, 1, 1], Vᵢⱼ=[1, 1, 1, 0, 1, 1, 0, 1, 1, 0, 1, 0, 1, 0, 1, 0, 0, 1, 0, 0, 0, 0, 0, 0, 1, 1], and Vᵢⱼ=[0, 0, 1, 1, 1, 0, 0, 1, 1, 1, 0, 1, 0, 1, 0, 1, 0, 1, 0, 0, 1, 1, 0, 0, 1, 1].

In some aspects, a tone exchange calibration (such as selection, configuration, or optimization) may be equivalent to (such as associated with) a switch vector calibration (such as selection, configuration, or optimization), which may, in some implementations, be subject to one or more constraints. For example, to minimize or limit dRU design changes associated with OOBE reduction, wireless nodes, via or otherwise in accordance with the switch vector 606 or regardless of the switch vector 606, may fix one or more tones when performing the tone exchange 600. For example, wireless nodes may fix the pilot tones of a dRU when doing the tone exchange, such that the pilot tones remain unchanged after the tone exchange 600. Wireless nodes may implement such a tone exchange restriction in accordance with maintaining the tone mappings for the second subset of (relatively larger) dRUs (such as the largest (and second largest) dRUs) associated with a given bandwidth, and because the pilot tone mapping may be defined for an entire distribution bandwidth. In other words, in some implementations, pilot tones may not participate in the tone exchange 600. In some aspects, such a restriction against a switching of tones that correspond to the pilot tones (or any other subset of tones of a dRU that are fixed) may be expressed by Equation 9.

Vᵢⱼ(pilots for dRU i and pilots for dRU j)=0 (9)

Additionally, or alternatively, wireless nodes may setup a feasible target for OOBE/power amplifier (PA) input backoff (IBO) (such as a transmit power backoff) reduction when selecting (such as identifying, configuring, generating, or constructing) the switch vector 606. For example, wireless nodes may set a threshold IBO (in terms of dB) for each relatively smaller dRU and may restrict (such as fix) one or more tones, such as one or more pilot tones, when selecting the switch vector 606. For example, the threshold IBO may be set by an AP 102 (and signaled to one or more STAs 104) or may bet set by a STA 104 (and signaled to an AP 102). For an LTF sequence associated with (such as corresponding to) a dRU in which additional tone spacing diversity has been introduced (including potentially in accordance with a switching or an adjusting of pilot tone indices), because a tone mapping may be changed relative to dRUs of other systems or generations of devices, a peak-to-average power ratio (PAPR) for the LTF may increase for the first subset of (relatively smaller) dRUs, if LTF sequences for such other systems or generations of devices are used. As such, in some implementations, wireless nodes may support a re-designed LTF sequence for dRUs due to the tone mapping change. In other words, an LTF sequence corresponding to a dRU of the first subset of (relatively smaller) dRUs may be associated with (such as specifically or exclusively constructed or usable for) the additional tone spacing diversity in that dRU. In some other implementations, wireless nodes may set a feasible target for LTF PAPR when calibrating (such as selecting, configuring, generating, or optimizing) the switch vector 606. In other words, the switch vector 606 may be based on a target PAPR associated with an LTF sequence corresponding to an indicated dRU of the first subset of (relatively smaller) dRUs. In some aspects, such a target PAPR may be higher than other PAPR values that might otherwise be used (such as that might be used for dRUs having at most three different tone spacings), but within an acceptable range for each of the dRUs of the first subset of (relatively smaller) dRUs. Such a switch vector 606 selected in accordance with the target PAPR may indicate which tones are to be fixed (such as by, for example, always indicating a value of 0 for corresponding tone indices), with such fixed tones, if present, potentially including one or more pilot tones. An AP 102 or a STA 104 may select, ascertain, determine, calculate, or otherwise identify the switch vector 606. The AP 102 may indicate the switch vector 606 to a STA 104 or the STA 104 may indicate the switch vector 606 to an AP 102.

As such, regarding pilot tone mapping, the dRU pilots for the entire bandwidth may be able to stay the same, or may be changed, but the pilot tone index table for each dRU may change in accordance with the introduction of the additional tone spacing diversity. In accordance with a potential switching of pilot tones, some dRUs may include fewer than two pilots, or may include more than two pilots.

Example dRU tone map and pilots in 20 MHz bandwidths, 40 MHZ bandwidths, and 80 MHz bandwidths may be illustrated by Tables 1, 2, and 3, respectively. In some implementations, the pilot tone indices for dRU transmissions may be fixed (and thus not switchable) and not switched between dRUs in accordance with the tone exchange 600. In some other implementations, the pilot tone indices for dRU transmissions may not be fixed (and thus switchable) and may be potentially switched between dRUs in accordance with the tone exchange 600. In the context of Tables 1-3, each bracket of tone indices may correspond to a different dRU index of a given dRU size/type. For example, for an original 20 MHz dRU26_1, the (two) pilot tones may be located at {−111 15}. A new 20 MHz dRU26_1 after the tone exchange 600 may have the same or different pilot tone indices. For further example, for an original 20 MHz dRU52_2, the (four) pilot tones may be located at {−100 −78 26 48}. A new 20 MHz dRU52_2 after the tone exchange 600 may have the same or different pilot tone indices.

TABLE 1
Pilot indices for dRU transmission over 20 MHz
Pilot indices for dRU transmission over 20 MHz

| dRU | |
|---|---|
| size/type | KdRUxx_i |
| dRU26, | {−111 15}, {−89 37}, {−100 26}, {−78 48}, {−67 59}, |
| i = 1:9 | {−56 70}, {−34 92}, {−45 81}, {−23 103} |
| dRU52, | {−111 −89 15 37}, {−100 −78 26 48}, {−56 −34 70 92}, |
| i = 1:4 | {−45 −23 81 103} |
| dRU106, | {−111 −78 15 48}, {−56 −23 70 103} |
| i = 1:2 | |

TABLE 2
Pilot indices for dRU transmission over 40 MHz
Pilot indices for dRU transmission over 40 MHz

| dRU | |
|---|---|
| size/type | KdRUxx_i |
| dRU26, | {−224 28}, {−125 127}, {−202 50}, {−103 149}, |
| i = 1:18 | {−81 171}, {−114 138}, {−213 39}, {−92 160}, |
| | {−191 61}, {−169 83}, {−70 182}, {−147 105}, |
| | {−48 204}, {−180 72}, {−59 193 }, {−158 94}, |
| | {−37 215}, {−136 116} |
| dRU52, | {−224 −125 28 127}, {−202 −103 50 149}, |
| i = 1:8 | {−213 −114 39 138}, {−191 −92 61 160}, |
| | {−169 −70 83 182}, {−147 −48 105 204}, |
| | {−158 −59 94 193}, {−136 −37 116 215} |
| dRU106, | {−224 −103 28 149}, {−213 −92 39 160}, |
| i = 1:4 | {−169 −48 83 204}, {−158 −37 94 215} |
| dRU242, | {−224 −213 −103 −92 28 39 149 160}, |
| i = 1:2 | {−169 −158 −48 −37 83 94 204 215} |

TABLE 3
Pilot indices for dRU transmission over 80 MHz
Pilot indices for dRU transmission over 80 MHz

| dRU | |
|---|---|
| size/type | KdRUxx_i |
| dRU26, | {−447 53}, {−359 141}, {−403 97}, {−315 185}, |
| i = 1:18, | {−271 229}, {−227 273}, {−139 361}, {−183 317}, |
| 20:37 | {−95 405}, {−117 383}, {−425 75}, {−73 427}, |
| | {−381 119}, {−161 339}, {−337 163}, {−249 251}, |
| | {−293 207}, {−205 295}, {−194 306}, {−106 394}, |
| | {−150 350}, {−62 438}, {−414 86}, {−370 130}, |
| | {−282 218}, {−326 174}, {−238 262}, {−260 240}, |
| | {−172 328}, {−216 284}, {−128 372}, {−304 196}, |
| | {−84 416}, {−392 108}, {−436 64}, {−348 152} |
| dRU52, | {−447 −359 53 141}, {−403 −315 97 185}, {−227 −139 |
| i = 1:16 | 273 361}, {−183 −95 317 405}, {−425 −117 75 383}, |
| | {−381 −73 119 427}, {−337 −249 163 251}, {−293 −205 |
| | 207 295}, {−194 −106 306 394}, {−150 −62 350 438}, |
| | {−370 −282 130 218}, {−326 −238 174 262}, {−260 −172 |
| | 240 328}, {−216 −128 284 372}, {−392 −84 108 416}, |
| | {−436 −348 64 152} |
| dRU106, | {−403 −315 97 185} , {−227 −139 273 361}, |
| i = 1:8 | {−381 −117 119 383}, {−293 −205 207 295}, {−150 −62 |
| | 350 438}, {−326 −238 174 262}, {−260 −172 240 328}, |
| | {−348 −84 152 416} |
| dRU242, | {−403 −315 −227 −139 97 185 273 361}, |
| i = 1:4 | {−381 −293 −205 −117 119 207 295 383}, |
| | {−326 −238 −150 −62 174 262 350 438}, |
| | {−348 −260 −172 −84 152 240 328 416} |
| dRU484, | {−403 −381 −315 −293 −227 −205 −139 −117 |
| i = 1:2 | 97 119 185 207 273 295 361 383}, |
| | {−348 −326 −260 −238 −172 −150 −84 −62 |
| | 152 174 240 262 328 350 416 438} |

Further, although illustrated and described in the example use of the switch vector 606, wireless nodes may switch, adjust, or otherwise change tone locations in accordance with any one or more other tone exchanging schemes. For example, wireless nodes may employ a tone index jitter of {+1, −1} (or {+2, −2}, and so on) on each if not all tones to randomize tone spacings or otherwise introduce additional diversity in tone spacings. Additionally, or alternatively, wireless nodes may locally-cyclically adjust dRU tone indices, such as via a random cyclic shift. For example, within each 4 tones (such as each set of 4 tones) in a total of 256 tones (such as for all fast Fourier transform (FFT) tones), wireless nodes may apply random shift from {−1, 1} in a cyclic way (such that tones within that 4 tone set are cyclically adjusted, such as to avoid interference or collision with other dRU transmissions in OFDMA communication systems). For example, for a 4 tone set of a first tone, a second tone, a third tone, and a fourth tone originally ordered from first to fourth, a wireless node may cyclically adjust the 4 tone set such that the wireless node may place the first tone in a location (such as a tone index) originally occupied by the second tone, may place the second tone in a location originally occupied by the third tone, may place the third tone in a location originally occupied by the fourth tone, and may place the fourth tone in a location originally occupied by the first tone. In some aspects, wireless nodes may locally-cyclically adjust dRU tone indices for some bandwidths and may employ the switch vector 606 for some other bandwidths. In some aspects, wireless nodes may locally-cyclically adjust dRU tone indices and employ the switch vector 606 for a given dRU.

In examples in which a wireless node locally-cyclically adjusts dRU tone indices, and in an example of a dRU26 with a 20 MHz bandwidth and with a 256-point (pt) FFT, random cyclic shifts may adjust a tone spacing of the dRU26 from an original tone spacing of: “9 9 9 9 9 9 9 9 9 9 9 9 [18] 9 9 9 9 9 9 9 9 9 9 9 9” to a new tone spacing of a tone exchanged dRU26 of: “7 7 7 13 7 11 5 15 5 9 9 13 [16] 5 15 5 11 5 15 5 9 9 13 7 9.” Such a new tone spacing may reduce PA IBO by at least a threshold amount and may reduce output backoff (OBO) by at least a threshold amount.

A bracketed tone index “[i]” may be understood as being indicative of a tone spacing between two consecutively populated or distributed tones around a DC tone, which may generally not count toward a quantity of unique tone spacings in a given dRU. In other words, as described herein, a quantity of unique/different tone spacings may generally refer to a quantity of distinct tone spacings in a dRU excluding the tone spacing around the DC tone. For example, a dRU associated with tone spacings of “4, 6, 8, [12], 4, 6, 8 . . . ” may be associated with a quantity of three different/unique/distinct tone spacings (namely, 4, 6, and 8), as the tone spacing of 12 around the DC tone may not be counted toward tone spacing diversity). A DC tone may be understood as or denote a Direct Current tone or a Direct Conversion tone. In some aspects, a DC tone may be associated with a center frequency, such as a center subcarrier index, of a given bandwidth.

FIG. 7 shows example dRU sets 700 that support reducing OOBE for transmissions associated with a dRU allocation. The dRU sets 700 (which may refer individually or collectively to any one or more of a dRU set 700-a, a dRU set 700-b, and a dRU set 700-c) may illustrate example complete sets of dRUs for various bandwidths, including 20 MHz, 40 MHz, and 80 MHz. The dRU sets 700 may further illustrate a grouping of subsets of the complete set, such as a first subset of dRUs 702 (which may refer individually or collectively to any one or more of a first subset of dRUs 702-a, a first subset of dRUs 702-b, and a first subset of dRUs 702-c) and a second subset of dRUs 704 (which may refer individually or collectively to any one or more of a second subset of dRUs 704-a, a second subset of dRUs 704-b, and a second subset of dRUs 704-c). Generally, the first subset of dRUs 702 may include two or more relatively smaller or smallest dRUs (in terms of quantity of tones) and the second subset of dRUs 704 may include at least one relatively larger or largest dRU (in terms of quantity of tones). For example, a first subset of dRUs 702 may include at least a smallest dRU associated with a given bandwidth, and a second subset of dRUs 704 may include at least a largest dRU associated with that given bandwidth.

With reference to the dRU set 700-a, in examples in which the bandwidth is 20 MHz, a first subset of dRUs 702-a may include a dRU26 (such as a first dRU having 26 tones) and a dRU52 (such as a second dRU having 52 tones). The first subset of dRUs 702-a including the dRU26 and the dRU52 may be understood as the first subset of dRUs 702-a including at least one dRU (such as 9 dRUs) associated with a dRU type of dRU26 and at least one dRU (such as 4 dRUs) associated with a dRU type of dRU52. In such examples in which the bandwidth is 20 MHz, a second subset of dRUs 704-a may include a dRU106. The second subset of dRUs 704-a including the dRU106 may be understood as the second subset of dRUs 704-a including at least one dRU (such as 2 dRUs) associated with a dRU type of dRU106.

In implementations in which wireless nodes support a tone exchange (such as the tone exchange 600) for dRUs of the first subset of dRUs 702-a, tone spacings resulting from the tone exchange for a dRU26 in 20 MHz may include a first set of different tone spacings of 7 tones, 9 tones, and 11 tones and tone spacings resulting from the tone exchange for a dRU52 in 20 MHz may include a second set of different tone spacings of 2 tones, 3 tones, 4 tones, 5 tones, 6 tones, and 7 tones. dRU106s in 20 MHz may offer relatively less transmit power gain and the tone spacings for the dRU106s may remain relatively even.

More specifically, a tone spacing change from the tone exchange for a dRU26 in 20 MHz may adjust a tone spacing of the dRU26 from an original tone spacing of: “9 9 9 9 9 9 9 9 9 9 9 9 [18] 9 9 9 9 9 9 9 9 9 9 9 9” to a new tone spacing of a tone exchanged dRU26 of: “7 11 7 9 11 7 11 9 9 7 11 9 [16] 9 11 7 9 9 11 9 9 7 11 9 7.” Such a new tone spacing may be the result of a selective (such as random) tone exchange between dRU26_1 and dRU26_3, and between dRU26_2 and dRU26_4 for a given tone index, assuming 20 MHz with a 256-pt FFT. For example, for a k^{th} tone index, a wireless node may randomly, pseudo-randomly, selectively, conditionally, or optionally perform a tone exchange between two different dRUs (each having the same size). Such a new tone spacing may reduce PA IBO by at least a threshold amount and may reduce OBO by at least a threshold amount.

Further, a tone spacing change from the tone exchange for a dRU52 in 20 MHz may adjust a tone spacing of the dRU52 from an original tone spacing of: “4 5 4 5 4 5 4 5 4 5 4 5 4 5 4 5 4 5 4 5 4 5 4 5 4 4 5 4 5 4 5 4 5 4 5 4 5 4 5 4 5 4 5 4 [14] 4 5 4 5 4” to a new tone spacing of a tone exchanged dRU52 of: “4 7 4 5 2 7 2 7 2 7 4 5 2 7 4 3 6 3 4 5 6 5 2 5 4 [14] 4 7 4 5 4 3 4 7 4 3 6 5 4 5 4 3 4 5 6 3 4 5 6 5 2.” Such a new tone spacing may be the result of a selective (such as random) tone exchange between dRU26_1 and dRU26_3, and between dRU26_2 and dRU26_4 for a given tone index, assuming 20 MHz with a 256-pt FFT. For example, for a k^{th} tone index, a wireless node may randomly, pseudo-randomly, selectively, conditionally, or optionally perform a tone exchange between two different dRUs (each having the same size). Such a new tone spacing may reduce PA IBO by at least a threshold amount and may reduce OBO by at least a threshold amount.

Further, maintaining the tone spacings for a dRU106 may maintain an original tone spacing of: “ . . . 2 2 2 3 2 2 2 3 2 2 2 3 2 2 2 3 2 2 2 3 [6] 3 2 2 2 3 2 2 2 3 2 2 . . . ” A determination to maintain the tone spacings for the dRU106 may be associated with a selective (such as random) tone exchange between dRU26_1 and dRU26_3, and between dRU26_2 and dRU26_4 for a given tone index, assuming 20 MHz with a 256-pt FFT, failing to reduce PA IBO by at least a threshold amount and failing to reduce OBO by at least a threshold amount.

With reference to the dRU set 700-b, in examples in which the bandwidth is 40 MHz, a first subset of dRUs 702-b may include a dRU26 (such as a first dRU having 26 tones), a dRU52 (such as a second dRU having 52 tones), and a dRU106 (such as a third dRU having 106 tones). The first subset of dRUs 702-b including the dRU26, the dRU52, and the dRU106 may be understood as the first subset of dRUs 702-b including at least one dRU (such as 19 dRUs) associated with a dRU type of dRU26, at least one dRU (such as 8 dRUs) associated with a dRU type of dRU52, and at least one dRU (such as 4 dRUs) associated with a dRU type of dRU106. In such examples in which the bandwidth is 40 MHz, a second subset of dRUs 704-b may include a dRU242. The second subset of dRUs 704-b including the dRU242 may be understood as the second subset of dRUs 704-b including at least one dRU (such as 2 dRUs) associated with a dRU type of dRU242.

In implementations in which wireless nodes support a tone exchange (such as the tone exchange 600) for dRUs of the first subset of dRUs 702-b, tone spacings resulting from the tone exchange for a dRU26 in 40 MHz may include a first set of different tone spacings of 16 tones, 18 tones, and 20 tones, tone spacings resulting from the tone exchange for a dRU52 in 40 MHz may include a second set of different tone spacings of 7 tones, 9 tones, and 11 tones, and tone spacings resulting from the tone exchange for a dRU106 in 40 MHz may include a third set of different tone spacings of 2 tones, 3 tones, 4 tones, 5 tones, 6 tones, and 7 tones. dRU242s in 40 MHz may offer relatively less transmit power gain and the tone spacings for the dRU242s may remain relatively even.

More specifically, a tone spacing change from the tone exchange for a dRU26 in 40 MHz may adjust a tone spacing of the dRU26 from an original tone spacing of: “18 18 18 18 18 18 18 18 18 18 18 18 [36] 18 18 . . . ” to a new tone spacing of a tone exchanged dRU26 of: “18 16 20 18 18 16 20 16 18 18 20 16 16 20 . . . ” Such a new tone spacing may be the result of a selective (such as random) tone exchange between dRU26_1 and dRU26_6, and between dRU26_2 and dRU26_7, and between dRU26_3 and dRU26_8, and between dRU26_4 and dRU26_9, for a given tone index, assuming 40 MHz with a 512-pt FFT. For example, for a k^{th} tone index, a wireless node may randomly, pseudo-randomly, selectively, conditionally, or optionally perform a tone exchange between two different dRUs (each having the same size). Such a new tone spacing may reduce PA IBO by at least a threshold amount and may reduce OBO by at least a threshold amount.

Further, a tone spacing change from the tone exchange for a dRU52 in 40 MHz may adjust a tone spacing of the dRU52 from an original tone spacing of: “ . . . 9 9 9 9 9 9 9 9 9 9 [27] 9 9 9 9 . . . ” to a new tone spacing of a tone exchanged dRU52 of: “ . . . 9 9 11 9 7 11 9 9 9 7 [29] 9 9 9 9 . . . ” Such a new tone spacing may be the result of a selective (such as random) tone exchange between dRU26_1 and dRU26_6, and between dRU26_2 and dRU26_7, and between dRU26_3 and dRU26_8, and between dRU26_4 and dRU26_9, for a given tone index, assuming 40 MHz with a 512-pt FFT. For example, for a k^{th} tone index, a wireless node may randomly, pseudo-randomly, selectively, conditionally, or optionally perform a tone exchange between two different dRUs (each having the same size). Such a new tone spacing may reduce PA IBO by at least a threshold amount and may reduce OBO by at least a threshold amount.

Further, a tone spacing change from the tone exchange for a dRU106 in 40 MHz may adjust a tone spacing of the dRU106 from an original tone spacing of: “ . . . 5 4 5 4 5 4 5 [13] 5 4 5 4 5 4 5 . . . ” to a new tone spacing of a tone exchanged dRU106 of: “ . . . 7 4 3 6 5 2 5 [13] 7 2 5 6 3 6 3 . . . ” Such a new tone spacing may be the result of a selective (such as random) tone exchange between dRU26_1 and dRU26_6, and between dRU26_2 and dRU26_7, and between dRU26_3 and dRU26_8, and between dRU26_4 and dRU26_9, for a given tone index, assuming 40 MHz with a 512-pt FFT. For example, for a k^{th} tone index, a wireless node may randomly, pseudo-randomly, selectively, conditionally, or optionally perform a tone exchange between two different dRUs (each having the same size). Such a new tone spacing may reduce PA IBO by at least a threshold amount and may reduce OBO by at least a threshold amount.

Further, maintaining the tone spacings for a dRU242 may maintain an original tone spacing of: “ . . . 2 2 [7] 2 2 2 1 2 2 2 3 2 2 2 2 1 2 . . . ” A determination to maintain the tone spacings for the dRU242 may be associated with a selective (such as random) tone exchange between dRU26_1 and dRU26_6, and between dRU26_2 and dRU26_7, and between dRU26_3 and dRU26_8, and between dRU26_4 and dRU26_9, for a given tone index, assuming 40 MHz with a 512-pt FFT, failing to reduce PA IBO by at least a threshold amount and failing to reduce OBO by at least a threshold amount.

With reference to the dRU set 700-c, in examples in which the bandwidth is 80 MHz, a first subset of dRUs 702-c may include a dRU52 (such as a first dRU having 52 tones) and a dRU106 (such as a second dRU having 106 tones). The first subset of dRUs 702-c including the dRU52 and the dRU106 may be understood as the first subset of dRUs 702-c including at least one dRU (such as 16 dRUs) associated with a dRU type of dRU52 and at least one dRU (such as 8 dRUs) associated with a dRU type of dRU106. The first subset of dRUs 702-c may further include at least one dRU (such as 37 dRUs) associated with a dRU type of dRU26. As described herein, a dRU52 may include two 26-tone dRUs. In such examples in which the bandwidth is 80 MHz, a second subset of dRUs 704-c may include a dRU242 and a dRU484. The second subset of dRUs 704-c including the dRU242 may be understood as the second subset of dRUs 704-c including at least one dRU (such as 4 dRUs) associated with a dRU type of dRU242 and the second subset of dRUs 704-c including the dRU484 may be understood as the second subset of dRUs 704-c including at least one dRU (such as 2 dRUs) associated with a dRU type of dRU484.

In implementations in which wireless nodes support a tone exchange (such as the tone exchange 600) for dRUs of the first subset of dRUs 702-c, tone spacings resulting from the tone exchange for a dRU52 in 80 MHz may include a first set of different tone spacings of 10 tones, 14 tones, 16 tones, 20 tones, 22 tones, and 26 tones, and tone spacings resulting from the tone exchange for a dRU106 in 80 MHz may include a second set of different tone spacings of 2 tones, 6 tones, 8 tones, 14 tones, and 18 tones. dRU242s and dRU484s in 80 MHz may offer relatively less transmit power gain and the tone spacings for the dRU242s and the dRU484s may remain relatively even. In some alternative scenarios, dRU242s may offer relatively sufficient (such as greater than or equal to a threshold amount) of transmit power gain. In such scenarios, the dRU242s may be included in the first subset of dRUs 702-c.

More specifically, a tone spacing change from the tone exchange for a dRU52 in 80 MHz may adjust a tone spacing of the dRU52 from an original tone spacing of: “ . . . 16 20 16 20 16 20 16 20 16 [52] 16 20 16 20 16 20 . . . ” to a new tone spacing of a tone exchanged dRU52 of: “ . . . 16 20 16 14 22 14 22 14 16 [52] 22 20 10 26 16 14 . . . ” Such a new tone spacing may be the result of a selective (such as random) tone exchange between dRU26_1 and dRU26_10, and between dRU26_2 and dRU26_11, and between dRU26_3 and dRU26_12, and between dRU26_4 and dRU26_13, and between dRU26_5 and dRU26_14, and between dRU26_6 and dRU26_15, and between dRU26_7 and dRU26_16, and between dRU26_8 and dRU26_17, and between dRU26_9 and dRU26_18, for a given tone index, assuming 80 MHz with a 1024-pt FFT. For example, for a k^{th} tone index, a wireless node may randomly, pseudo-randomly, selectively, conditionally, or optionally perform a tone exchange between two different dRUs (each having the same size). Such a new tone spacing may reduce PA IBO by at least a threshold amount and may reduce OBO by at least a threshold amount.

Further, a tone spacing change from the tone exchange for a dRU106 in 80 MHz may adjust a tone spacing of the dRU106 from an original tone spacing of: “ . . . 12 8 8 8 12 8 8 8 [44] 8 8 8 12 8 8 8 . . . ” to a new tone spacing of a tone exchanged dRU106 of: “ . . . 18 2 14 8 6 8 14 8 [44] 8 2 14 6 14 2 14 . . . ” Such a new tone spacing may be the result of a selective (such as random) tone exchange between dRU26_1 and dRU26_10, and between dRU26_2 and dRU26_11, and between dRU26_3 and dRU26_12, and between dRU26_4 and dRU26_13, and between dRU26_5 and dRU26_14, and between dRU26_6 and dRU26_15, and between dRU26_7 and dRU26_16, and between dRU26_8 and dRU26_17, and between dRU26_9 and dRU26_18, for a given tone index, assuming 80 MHz with a 1024-pt FFT. For example, for a k^{th} tone index, a wireless node may randomly, pseudo-randomly, selectively, conditionally, or optionally perform a tone exchange between two different dRUs (each having the same size). Such a new tone spacing may reduce PA IBO by at least a threshold amount and may reduce OBO by at least a threshold amount.

In scenarios in which dRU242s are included in the first subset of dRUs 702-c, a tone spacing change from the tone exchange for a dRU242 in 80 MHz may adjust a tone spacing of the dRU242 from an original tone spacing of: “ . . . 4 4 4 4 4 4 4 4 [36] 4 4 4 4 4 4 . . . ” to a new tone spacing of a tone exchanged dRU242 of: . . . 2 6 2 2 2 6 4 4 [38] 4 2 4 8 2 6 . . . .” Such a new tone spacing may be the result of a selective (such as random) tone exchange between dRU26_1 and dRU26_10, and between dRU26_2 and dRU26_11, and between dRU26_3 and dRU26_12, and between dRU26_4 and dRU26_13, and between dRU26_5 and dRU26_14, and between dRU26_6 and dRU26_15, and between dRU26_7 and dRU26_16, and between dRU26_8 and dRU26_17, and between dRU26_9 and dRU26_18, for a given tone index, assuming 80 MHz with a 1024-pt FFT. For example, for a k^{th} tone index, a wireless node may randomly, pseudo-randomly, selectively, conditionally, or optionally perform a tone exchange between two different dRUs (each having the same size). Such a new tone spacing may reduce PA IBO by at least a threshold amount and may reduce OBO by at least a threshold amount.

Alternatively, in scenarios in which dRU242s are included in the second subset of dRUs 704-c, maintaining the tone spacings for a dRU242 may maintain an original tone spacing of: “ . . . 4 4 4 4 4 4 4 4 [36] 4 4 4 4 4 4 . . . .” A determination to maintain the tone spacings for the dRU242 may be associated with a selective (such as random) tone exchange between dRU26_1 and dRU26_6, and between dRU26_2 and dRU26_7, and between dRU26_3 and dRU26_8 and between dRU26_4 and dRU26_9, and between dRU26_5 and dRU26_14, and between dRU26_10 and dRU26_15, and between dRU26_11 and dRU26_16, and between dRU26_12 and dRU26_17, and between dRU26_13 and dRU26_18, for a given tone index, assuming 80 MHz with a 1024-pt FFT, failing to reduce PA IBO by at least a threshold amount and failing to reduce OBO by at least a threshold amount.

Further, maintaining the tone spacings for a dRU484 may maintain an original tone spacing of: “ . . . 2 [34] 2 2 2 2 2 2 2 2 2 2 2 2 2 2 . . . .” A determination to maintain the tone spacings for the dRU484 may be associated with a random tone exchange between dRU26_1 and dRU26_6, and between dRU26_2 and dRU26_7, and between dRU26_3 and dRU26_8 and between dRU26_4 and dRU26_9, and between dRU26_5 and dRU26_14, and between dRU26_10 and dRU26_15, and between dRU26_11 and dRU26_16, and between dRU26_12 and dRU26_17, and between dRU26_13 and dRU26_18, for a given tone index, assuming 80 MHz with a 1024-pt FFT, failing to reduce PA IBO by at least a threshold amount and failing to reduce OBO by at least a threshold amount.

FIG. 8 shows an example dRU design 800 for a 20 MHz bandwidth that supports reducing OOBE for transmissions associated with a dRU allocation. The dRU design 800 may illustrate a hierarchical structure of dRUs of different dRU types associated with a bandwidth of 20 MHz. As described herein, a subcarrier range may be denoted or defined by three numbers. For example, a subcarrier range may be denoted or defined by [x, y, z], where x may be indicative of a starting subcarrier index, y may be indicative of an interval or separation distance (between two consecutively populated tones), and z may be indicative of an ending subcarrier index. Further, a subcarrier range may be denoted or defined by a combination of two or more subcarrier ranges. For example, a subcarrier range may be denoted or defined by [X, Y], where X may be indicative of a first range and Y may be indicative of a second range, the subcarrier range including X+Y.

In some aspects, the dRU26_1 may be associated with a subcarrier range of [−120:9:−12, 6:9:114], the dRU26_2 may be associated with a subcarrier range of [−116:9:−8, 10:9:118], the dRU26_3 may be associated with a subcarrier range of [−118:9:−10, 8:9:116], the dRU26_4 may be associated with a subcarrier range of [−114:9:−6, 12:9:120], the dRU26_5 may be associated with a subcarrier range of [−112:9:−4, 5:9:113], the dRU26_6 may be associated with a subcarrier range of [−119:9:−11, 7:9:115], the dRU26_7 may be associated with a subcarrier range of [−115:9:−7, 11:9:119], the dRU26_8 may be associated with a subcarrier range of [−117:9:−9, 9:9:117], and the dRU26_9 may be associated with a subcarrier range of [−113:9:−5, 4:9:112]. In some aspects, such subcarrier ranges may be associated with original dRU26s, such that subcarriers/tones within such subcarrier ranges may be randomly switched between different dRU26s to introduce additional diversity in tone spacings in the different dRU26s.

A dRU52_1 may include two 26-tone dRUs, namely dRU26_1 and dRU26_2, a dRU52_2 may include two 26-tone dRUs, namely dRU26_3 and dRU26_4, a dRU52_3 may include two 26-tone dRUs, namely dRU26_6 and dRU26_7, and a dRU52_4 may include two 26-tone dRUs, namely dRU26_8 and dRU26_9. A dRU106_1 may include four 26-tone dRUs, namely dRU26_1, dRU26_2, dRU26_3, and dRU26_4 and two additional tones [−3, 3], and a dRU106_2 may include four dRUs, namely dRU26_6, dRU26_7, dRU26_8, and dRU26_9 and two additional tones [−2, 2].

In some aspects, the dRU26_5 may not be linked to any other dRUs in the hierarchical structure of 20 MHz except for the full bandwidth RU242. Further, two dRU106s may occupy 212 tones out of a total of 242 tones, such that there may be 30 tones left to place the 26 tones of the dRU26_5. In other words, there may be additional freedom to move around the tones of the dRU26_5, but the manner in which the tones of the dRU26_5 may be moved is different from other dRU26s that are linked to larger dRUs.

An example of a modified dRU tone plan for a 20 MHz bandwidth is illustrated by Table 4, below. The modified tone mapping for a 20 MHz bandwidth illustrated by Table 4 may be an example of a modified tone mapping after a tone exchange, such as after the tone exchange 600. For example, a wireless node may employ, use, perform, or otherwise leverage the tone exchange 600 (along with, or separate from, a tone index jitter or a cyclic shift) to realize, create, generate, or otherwise obtain the modified tone mapping illustrated by Table 4. Further, in accordance with the modified tone mapping illustrated by Table 4 and some example implementations of the present disclosure, 26-tone dRUs and 52-tone dRUs may have modified tone mappings, while there may be no change to the tone plans of the 106-tone dRUs. In other words, additional tone spacing diversity may be introduced for the 26-tone dRUs and 52-tone dRUs (such as for transmit power gain), while relatively more even tone spacings may be maintained for the 106-tone dRUs (such as for channel smoothing support).

TABLE 4
Modified dRU 20 MHz Tone Plan

| dRU | | |
|---|---|---|
| type | dRU index and subcarrier range | |
| 26-tone | dRU1 | [−118 −111 −102 −91 −84 −73 −66 −57 −48 −37 −28 −21 −10 |
| dRU | | 6 15 24 33 44 53 60 69 78 89 96 105 116] |
| i = 1:9 | dRU2 | [−114 −107 −98 −89 −80 −69 −62 −53 −44 −33 −24 −15 −6 |
| | | 12 19 30 37 46 55 64 73 84 93 100 111 118] |
| | dRU3 | [−120 −109 −100 −93 −82 −75 −64 −55 −46 −39 −30 −19 −12 |
| | | 8 17 26 35 42 51 62 71 80 87 98 107 114] |
| | dRU4 | [−116 −105 −96 −87 −71 −60 −51 −42 −35 −26 −17 −8 |
| | | 10 21 28 39 48 57 66 75 82 91 102 109 120] |
| | dRU5 | [−122 −103 −94 −85 −76 −67 −58 −49 −40 −31 −22 −13 −4 |
| | | 5 14 23 32 41 50 59 68 77 86 104 113 121] |
| | dRU6 | [−117 −110 −101 −90 −83 −74 −65 −56 −47 −38 −27 −18 −11 |
| | | 9 16 25 34 45 52 61 70 79 90 99 106 117] |
| | dRU7 | [−115 −106 −97 −86 −77 −68 −59 −50 −41 −34 −25 −14 −7 |
| | | 4 13 29 31 47 49 58 74 76 92 94 110 112] |
| | dRU8 | [−119 −108 −99 −92 −81 −72 −63 −54 −45 −36 −29 −20 −9 |
| | | 7 18 27 36 43 54 63 72 81 88 97 108 115] |
| | dRU9 | [−113 −104 −95 −88 −79 −70 −61 −52 −43 −32 −23 −16 −5 |
| | | 11 20 22 38 40 56 65 67 83 85 101 103 119] |

| | | |
|---|---|---|
| 52-tone | dRU1 | dRU2 |
| dRU | 26-tone [dRU1, dRU2] | 26-tone [dRU3, dRU4] |
| i = 1:4 | dRU3 | dRU4 |
| | 26-tone [dRU6, dRU7] | 26-tone [dRU8, dRU9] |
| 106-tone | dRU1 | dRU2 |
| dRU | 26-tone [dRU1~4], [−3, 3] | 26-tone [dRU6~9], [−2, 2] |
| i = 1:2 | | |

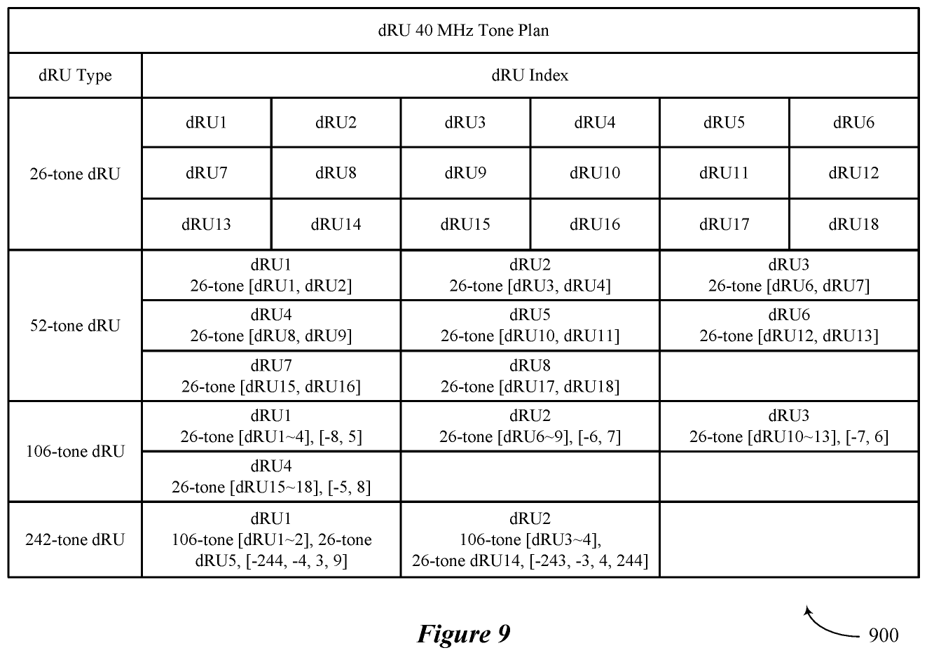

FIG. 9 shows an example dRU design 900 for a 40 MHz bandwidth that supports reducing OOBE for transmissions associated with a dRU allocation. The dRU design 900 may illustrate a hierarchical structure of dRUs of different dRU types associated with a bandwidth of 40 MHz.

In some aspects, the dRU26_1 may be associated with a subcarrier range of [−242:18:−26, 10:18:226], the dRU26_2 may be associated with a subcarrier range of [−233:18:−17, 19:18:235], the dRU26_3 may be associated with a subcarrier range of [−238:18:−22, 14:18:230], the dRU26_4 may be associated with a subcarrier range of [−229:18:−13, 23:18:239], the dRU26_5 may be associated with a subcarrier range of [−225:18:−9, 27:18:243], the dRU26_6 may be associated with a subcarrier range of [−240:18:−24, 12:18:228], the dRU26_7 may be associated with a subcarrier range of [−231:18:−15, 21:18:237], the dRU26_8 may be associated with a subcarrier range of [−236:18:−20, 16:18:232], the dRU26_9 may be associated with a subcarrier range of [−227:18:−11, 25:18:241], the dRU26_10 may be associated with a subcarrier range of [−241:18:−25, 11:18:227], the dRU26_11 may be associated with a subcarrier range of [−232:18:−16, 20:18:236], the dRU26_12 may be associated with a subcarrier range of [−237:18:−21, 15:18:231], the dRU26_13 may be associated with a subcarrier range of [−228:18:−12, 24:18:240], the dRU26_14 may be associated with a subcarrier range of [−234:18:−18, 18:18:234], the dRU26_15 may be associated with a subcarrier range of [−239:18:−23, 13:18:229], the dRU26_16 may be associated with a subcarrier range of [−230:18:−14, 22:18:238], the dRU26_17 may be associated with a subcarrier range of [−235:18:−19, 17:18:233], and the dRU26_18 may be associated with a subcarrier range of [−226:18:−10, 26:18:242]. In some aspects, such subcarrier ranges may be associated with original dRU26s, such that subcarriers/tones within such subcarrier ranges may be randomly switched between different dRU26s to introduce additional diversity in tone spacings in the different dRU26s.

The dRU52s may each include a respective set of two dRU26s. For example, the dRU52_1 may include the dRU26_1 and the dRU26_2 or may be associated with a subcarrier range of [−242:9:−17, 10:9:235] (because, for example, dRU26_1 and dRU26_2 may be interleaved), the dRU52_2 may include the dRU26_3 and the dRU26_4 or may be associated with a subcarrier range of [−238:9:−13, 14:9:239], the dRU52_3 may include the dRU26_6 and the dRU26_7 or may be associated with a subcarrier range of [−240:9:−15, 12:9:237], the dRU52_4 may include the dRU26_8 and the dRU26_9 or may be associated with a subcarrier range of [−236:9:−11, 16:9:241], and so on. The dRU106s may each include a respective set of four dRU26s and the dRU242s may each include a respective set of two dRU106s and a respective dRU26.

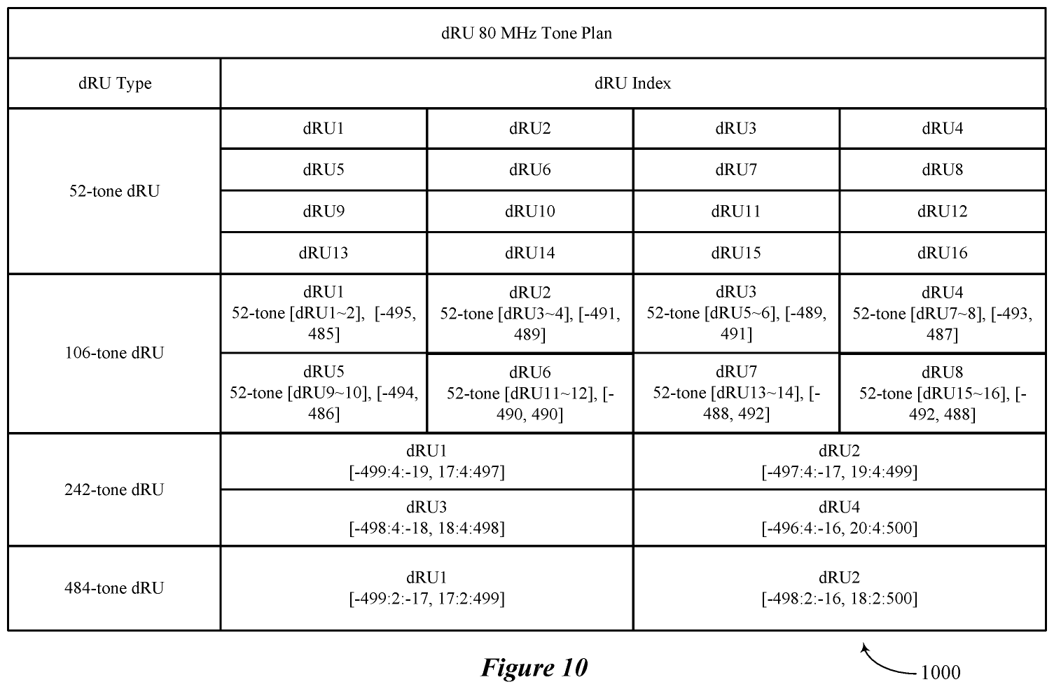

FIG. 10 shows an example dRU design 1000 for an 80 MHz bandwidth that supports reducing OOBE for transmissions associated with a dRU allocation. The dRU design 1000 may illustrate a hierarchical structure of dRUs of different dRU types associated with a bandwidth of 80 MHZ.

In some aspects, the dRU52_1 may be associated with a subcarrier range of [−483:36:−51, 17:36:449], [−467:36:−35, 33:36:465], the dRU52_2 may be associated with a subcarrier range of [−475:36:−43, 25:36:457], [−459:36:−27, 41:36:473], the dRU52_3 may be associated with a subcarrier range of [−479:36:−47, 21:36:453], [−463:36:−31, 37:36:469], the dRU52_4 may be associated with a subcarrier range of [−471:36:−39, 29:36:461], [−455:36:−23, 45:36:477], the dRU52_5 may be associated with a subcarrier range of [−477:36:−45, 23:36:455], [−461:36:−29, 39:36:471], the dRU52_6 may be associated with a subcarrier range of [−469:36:−37, 31:36:463], [−453:36:−21, 47:36:479], the dRU52_7 may be associated with a subcarrier range of [−481:36:−49, 19:36:451], [−465:36:−33, 35:36:467], the dRU52_8 may be associated with a subcarrier range of [−473:36:−41, 27:36:459], [−457:36:−25, 43:36:475], the dRU52_9 may be associated with a subcarrier range of [−482:36:−50, 18:36:450], [−466:36:−34, 34:36:466], the dRU52_10 may be associated with a subcarrier range of [−474:36:−42, 26:36:458], [−458:36:−26, 42:36:474], the dRU52_11 may be associated with a subcarrier range of [−478:36:−46, 22:36:454], [−462:36:−30, 38:36:470], the dRU52_12 may be associated with a subcarrier range of [−470:36:−38, 30:36:462], [−454:36:−22, 46:36:478], the dRU52_13 may be associated with a subcarrier range of [−476:36:−44, 24:36:456], [−460:36:−28, 40:36:472], the dRU52_14 may be associated with a subcarrier range of [−468:36:−36, 32:36:464], [−452:36:−20, 48:36:480], the dRU52_15 may be associated with a subcarrier range of [−480:36:−48, 20:36:452], [−464:36:−32, 36:36:468], the dRU52_16 may be associated with a subcarrier range of [−472:36:−40, 28:36:460], [−456:36:−24, 44:36:476]. In some aspects, such subcarrier ranges may be associated with original dRU26s or original dRU52s, such that subcarriers/tones within such subcarrier ranges may be randomly switched between different dRU26s or between different dRU52s to introduce additional diversity in tone spacings in the different dRU52s. A 52-tone dRU may include two 26-tone dRUs such that the sixteen 52-tone dRUs may be understood as including at least thirty-two 26-tone dRUs.

The dRU106s may each include a respective set of two dRU52s and a quantity of additional tones. For example, the dRU106_1 may include the dRU52_1 and the dRU52_2 and additional tones [−495, 485], the dRU106_2 may include the dRU52_3 and the dRU52_4 and additional tones [−491, 489], the dRU106_3 may include the dRU52_5 and the dRU52_6 and additional tones [−489, 491], and so on. The dRU242_1 may be associated with a subcarrier range of [−499:4:−19, 17:4:497], the dRU242_2 may be associated with a subcarrier range of [−497:4:−17, 19:4:499], the dRU242_3 may be associated with a subcarrier range of [−498:4:−18, 18:4:498], and the dRU242_4 may be associated with a subcarrier range of [−496:4:−16, 20:4:500]. The dRU484_1 may be associated with a subcarrier range of [−499:2:−17, 17:2:499] and the dRU484_2 may be associated with a subcarrier range of [−498:2:−16, 18:2:500].

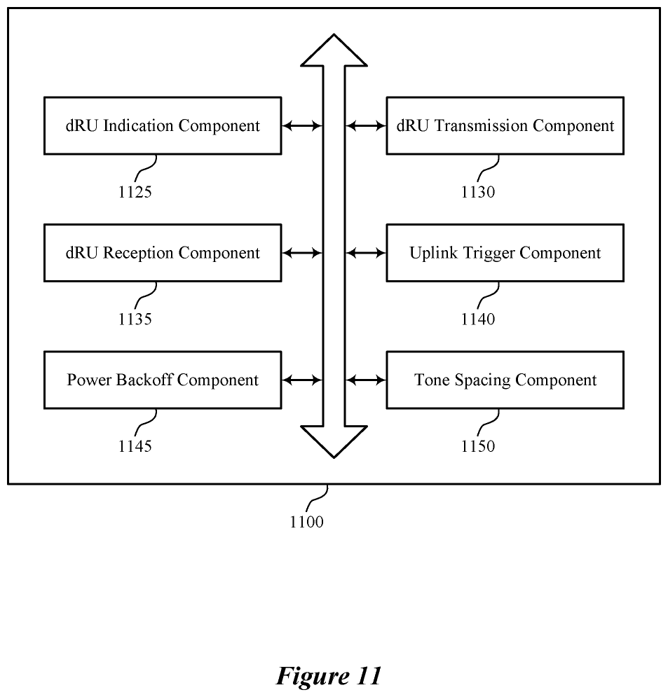

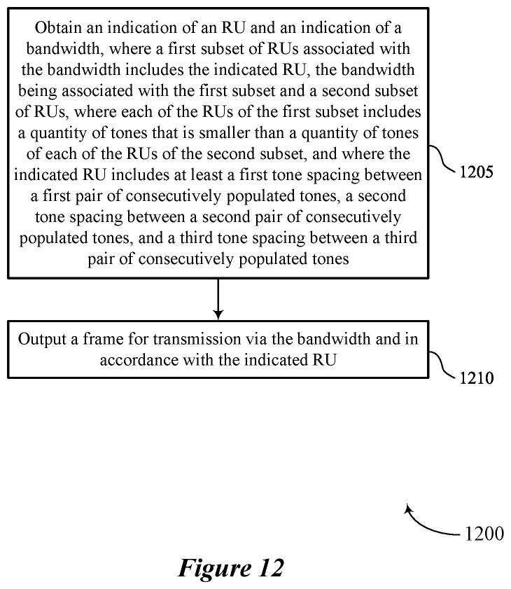

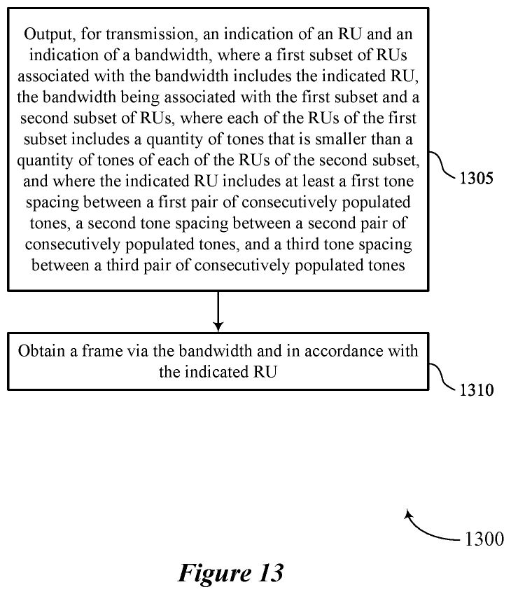

FIG. 11 shows a block diagram of an example wireless communication device 1100 that supports reducing OOBE for transmissions associated with a dRU allocation. In some examples, the wireless communication device 1100 is configured to perform the processes 1200 and 1300 described with reference to FIGS. 12 and 13, respectively. The wireless communication device 1100 may include one or more chips, SoCs, chipsets, packages, components or devices that individually or collectively constitute or include a processing system. The wireless communication device 1100 may be equivalently referred to as a wireless node, and may be or include an apparatus for wireless communication. The processing system may interface with other components of the wireless communication device 1100, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1100 may transmit the information output from the chip. In such an example, the second interface may refer to an interface between the processing system of the chip and a reception component, such that the wireless communication device 1100 may receive information that is passed to the processing system. In some such examples, the first interface also may obtain information, such as from the transmission component, and the second interface also may output information, such as to the reception component.

As such, as described herein, outputting information, a packet, a frame, or a message for transmission may be understood as signaling between two or more components of the wireless communication device 1100, such as signaling from a processing system to one or more transceivers. Similarly, as described herein, obtaining information, a packet, a frame, or a message may be understood as signaling between two or more components of the wireless communication device 1100, such as signaling from one or more transceivers to a processing system. Additionally, or alternatively, outputting information, a packet, a frame, or a message may be understood as transmitting over-the-air, such as via or from one or more transceivers. Similarly, obtaining information, a packet, a frame, or a message may, additionally, or alternatively, be understood as receiving over-the-air, such as via or at one or more transceivers.

Further, various components of the wireless communication device 1100 may provide means for performing the methods described herein. In some examples, means for transmitting and/or receiving may include the transceivers and/or antenna(s) of the wireless communication device 1100. In some examples, means for outputting or sending (such as means for outputting for transmission) and means for obtaining (such as means for obtaining after information is received from a different device) may include one or more interfaces of the wireless communication device 1100 to output signals to other components or obtain signals from other components of the wireless communication device 1100. For example, a processor (of a processing system) may output (such as provide) signals and/or data, via a bus interface, to a radio frequency front end for transmission. Similarly, rather than actually receiving signals and/or data, a device may have an interface to obtain the signals and/or data received from another device (a means for obtaining). For example, a processor (of a processing system) may obtain (or receive) the signals and/or data, via a bus interface, from a radio frequency front end for reception. In various aspects, a radio frequency front end may include various components, including transmit and receive processors, transmit and receive MIMO processors, modulators, demodulators, and the like. Each of means for determining, means for identifying, means for selecting, means for using, means for employing, means for performing, means for leveraging, means for setting, means for adjusting, means for configuring, means for generating, means for calibrating, and/or means for switching include a processing system, processor circuitry (including one or more processors), memory circuitry, and/or computer-readable media of the wireless communication device 1100.

The processing system of the wireless communication device 1100 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1100 can configurable or configured for use in an AP or STA, such as the AP 102 or the STA 104 described with reference to FIG. 1. In some other examples, the wireless communication device 1100 can be an AP or STA that includes such a processing system and other components including multiple antennas. The wireless communication device 1100 is capable of transmitting and receiving wireless communications in the form of, for example, wireless packets. For example, the wireless communication device 1100 can be configurable or configured to transmit and receive packets in the form of physical layer PPDUs and MPDUs conforming to one or more of the IEEE 802.11 family of wireless communication protocol standards. In some other examples, the wireless communication device 1100 can be configurable or configured to transmit and receive signals and communications conforming to one or more 3GPP specifications including those for 5G NR or 6G. In some examples, the wireless communication device 1100 also includes or can be coupled with one or more application processors which may be further coupled with one or more other memories. In some examples, the wireless communication device 1100 further includes a user interface (UI) (such as a touchscreen or keypad) and a display, which may be integrated with the UI to form a touchscreen display that is coupled with the processing system. In some examples, the wireless communication device 1100 may further include one or more sensors such as, for example, one or more inertial sensors, accelerometers, temperature sensors, pressure sensors, or altitude sensors, that are coupled with the processing system. In some examples, the wireless communication device 1100 further includes at least one external network interface coupled with the processing system that enables communication with a core network or backhaul network that enables the wireless communication device 1100 to gain access to external networks including the Internet.

The wireless communication device 1100 includes a dRU indication component 1125, a dRU transmission component 1130, a dRU reception component 1135, an uplink trigger component 1140, a power backoff component 1145, and a tone spacing component 1150. Portions of one or more of the dRU indication component 1125, the dRU transmission component 1130, the dRU reception component 1135, the uplink trigger component 1140, the power backoff component 1145, and the tone spacing component 1150 may be implemented at least in part in hardware or firmware. For example, one or more of the dRU indication component 1125, the dRU transmission component 1130, the dRU reception component 1135, the uplink trigger component 1140, the power backoff component 1145, and the tone spacing component 1150 may be implemented at least in part by at least a processor or a modem. In some examples, portions of one or more of the dRU indication component 1125, the dRU transmission component 1130, the dRU reception component 1135, the uplink trigger component 1140, the power backoff component 1145, and the tone spacing component 1150 may be implemented at least in part by a processor and software in the form of processor-executable code stored in memory.

The wireless communication device 1100 may support wireless communication in accordance with examples as disclosed herein. The dRU indication component 1125 is configurable or configured to obtain an indication of an RU and an indication of a bandwidth, where a first subset of RUs associated with the bandwidth includes the indicated RU, the bandwidth being associated with the first subset and a second subset of RUs, where each of the RUs of the first subset includes a quantity of tones that is smaller than a quantity of tones of each of the RUs of the second subset, and where the indicated RU includes at least a first tone spacing between a first pair of consecutively populated tones, a second tone spacing between a second pair of consecutively populated tones, and a third tone spacing between a third pair of consecutively populated tones. The dRU transmission component 1130 is configurable or configured to output a frame for transmission via the bandwidth and in accordance with the indicated RU.

In some examples, the uplink trigger component 1140 is configurable or configured to obtain a trigger frame soliciting the frame, where the trigger frame includes the indication of the RU and the indication of the bandwidth, and where the frame is output after obtaining the trigger frame.

In some examples, the power backoff component 1145 is configurable or configured to set a power backoff parameter to a value in accordance with the indicated RU, where the frame is output for transmission based on the power backoff parameter.

In some examples, a set of RUs associate with the bandwidth includes the first subset of RUs and the second subset of RUs.

In some examples, each of the RUs of the first subset be independent of a channel smoothing scheme. In such examples, the dRU reception component 1135 is configurable or configured to refrain, for a time period, from applying a channel smoothing scheme for each resource unit of the first subset of RUs.

In some examples, the RUs of the first subset be associated with at least a first quantity of tone spacings and the RUs of the second subset are associated with at most a second quantity of tone spacings, the first quantity of tone spacings being greater than or equal to the second quantity of tone spacings.

In some examples, the first subset of RUs include at least two RUs, the at least two RUs including a first RU having a first quantity of tones and a second RU having a second quantity of tones that is greater than the first quantity of tones.

In some examples, the first RU have the first quantity of tones is associated with a first set of three or more different tone spacings, and the second RU having the second quantity of tones is associated with a second set of three or more different tone spacings.

In some examples, the indicate RU includes at least a first RU and a second RU.

In some examples, the tone spacing component 1150 is configurable or configured to switch one or more first tones of the indicated RU with one or more second tones of a second RU in accordance with a switch vector, each of the indicated RU and the second RU having a same quantity of tones and the second RU being included in the first subset of RUs, where the first tone spacing, the second tone spacing, and the third tone spacing are associated with the switch vector.

In some examples, a subset of tone indices associate with the indicated RU and the second RU are fixed, the switch vector indicating a restriction against switching of tones that correspond to the subset of tone indices. In other words, the switch vector indicates a restriction against switching of tones that correspond to a subset of tone indices.

In some examples, pilot tone indices associate with the indicated RU and the second RU are not fixed, the switch vector indicating an allowance of switching of tones that correspond to the pilot tone indices. In other words, the switch vector indicates an allowance of switching of tones that correspond to a set of pilot tone indices.

In some examples, an LTF sequence corresponding to the indicate RU is associated with the first tone spacing, the second tone spacing, and the third tone spacing.

In some examples, the switch vector be based on a target PAPR associated with an LTF sequence corresponding to the indicated RU.

In some examples, the bandwidth be 20 MHz, the first subset of RUs including a first RU having x tones, and a second RU having y tones.

In some examples, the first RU have x tones is associated at least with a first set of different tone spacings, and the second RU having y tones is associated at least with a second set of different tone spacings.

In some examples, x=26, and the first set of different tone spacings include tone spacings of a tones, b tones, and c tones, and y=52, and the second set of different tone spacings includes tone spacings of d tones, e tones, f tones, g tones, h tones, and i tones.

In some examples, a=7, b=9, and c=11, and d=2, e=3, f=4, g=5, h=6, and i=7.

In some examples, the second subset of RUs include a third RU having z tones.

In some examples, z=106.

In some examples, the bandwidth be 40 MHz, the first subset of RUs including a first RU having x tones, a second RU having y tones, and a third RU having z tones.

In some examples, the first RU have x tones is associated at least with a first set of different tone spacings, the second RU having y tones is associated at least with a second set of different tone spacings, and the third RU having z tones is associated at least with a third set of different tone spacings.

In some examples, x=26, and the first set of different tone spacings include tone spacings of a tones, b tones, and c tones, y=52, and the second set of different tone spacings includes tone spacings of d tones, e tones, and f tones, and z=106, and the third set of different tone spacings includes tone spacings of g tones, h tones, i tones, j tones, k tones, and 1 tones.

In some examples, a=16, b=18, and c=20, d=7, e=9, and f=11, and g=2, h=3, i=4, j=5, k=6, and 1=7.

In some examples, the second subset of RUs include a fourth RU having w tones.

In some examples, w=242.

In some examples, the bandwidth be 80 MHz, the first subset of RUs including a first RU having x tones, and a second RU having y tones.

In some examples, the first RU have x tones is associated at least with a first set of different tone spacings, and the second RU having y tones is associated at least with a second set of different tone spacings.

In some examples, x=52, and the first set of different tone spacings include tone spacings of a tones, b tones, c tones, d tones, e tones, and f tones, and y=106, and the second set of different tone spacings includes tone spacings of g tones, h tones, i tones, j tones, and k tones.

In some examples, a=10, b=14, c=16, d=20, e=22, and f=26, and g=2, h=6, i=8, j=14, and k=18.

In some examples, the second subset of RUs include a third RU having z tones and includes a fourth RU having w tones.

In some examples, z=242, and w=484.

Additionally, or alternatively, the wireless communication device 1100 may support wireless communication in accordance with examples as disclosed herein. In some examples, the dRU indication component 1125 is configurable or configured to output, for transmission, an indication of an RU and an indication of a bandwidth, where a first subset of RUs associated with the bandwidth includes the indicated RU, the bandwidth being associated with the first subset and a second subset of RUs, where each of the RUs of the first subset includes a quantity of tones that is smaller than a quantity of tones of each of the RUs of the second subset, and where the indicated RU includes at least a first tone spacing between a first pair of consecutively populated tones, a second tone spacing between a second pair of consecutively populated tones, and a third tone spacing between a third pair of consecutively populated tones. The dRU reception component 1135 is configurable or configured to obtain a frame via the bandwidth and in accordance with the indicated RU.

In some examples, the uplink trigger component 1140 is configurable or configured to output, for transmission, a trigger frame soliciting the frame, where the trigger frame includes the indication of the RU and the indication of the bandwidth, and where the frame is obtained after outputting the trigger frame.

In some examples, a set of RUs associate with the bandwidth includes the first subset of RUs and the second subset of RUs.

In some examples, each of the RUs of the first subset be independent of a channel smoothing scheme. In such examples, the dRU reception component 1135 is configurable or configured to refrain, for a time period, from applying a channel smoothing scheme for each resource unit of the first subset of RUs.

In some examples, the RUs of the first subset be associated with at least a first quantity of tone spacings and the RUs of the second subset are associated with at most a second quantity of tone spacings, the first quantity of tone spacings being greater than or equal to the second quantity of tone spacings.

In some examples, the subset of RUs include at least two RUs, the at least two RUs including a first RU having a first quantity of tones, and a second RU having a second quantity of tones that is greater than the first quantity of tones.

In some examples, the first RU have the first quantity of tones is associated with a first set of three or more different tone spacings, and the second RU having the second quantity of tones is associated with a second set of three or more different tone spacings.

In some examples, the indicate RU includes at least a first RU and a second RU.

In some examples, the tone spacing component 1150 is configurable or configured to switch one or more first tones of the indicated RU with one or more second tones of a second RU in accordance with a switch vector, each of the indicated RU and the second RU having a same quantity of tones and the second RU being included in the first subset of RUs, where the first tone spacing, the second tone spacing, and the third tone spacing are associated with the switch vector.

In some examples, a subset of tone indices associate with the indicated RU and the second RU are fixed, the switch vector indicating a restriction against switching of tones that correspond to the subset of tone indices. In other words, the switch vector indicates a restriction against switching of tones that correspond to a subset of tone indices.

In some examples, pilot tone indices associate with the indicated RU and the second RU are not fixed, the switch vector indicating an allowance of switching of tones that correspond to the pilot tone indices. In other words, the switch vector indicates an allowance of switching of tones that correspond to a set of pilot tone indices.

In some examples, an LTF sequence corresponding to the indicate RU is associated with the first tone spacing, the second tone spacing, and the third tone spacing.

In some examples, the switch vector be based on a target PAPR associated with an LTF sequence corresponding to the indicated RU.

In some examples, the bandwidth be 20 MHz, the first subset of RUs including a first RU having x tones, and a second RU having y tones.

In some examples, the first RU have x tones is associated at least with a first set of different tone spacings, and the second RU having y tones is associated at least with a second set of different tone spacings.

In some examples, x=26, and the first set of different tone spacings include tone spacings of a tones, b tones, and c tones, and y=52, and the second set of different tone spacings includes tone spacings of d tones, e tones, f tones, g tones, h tones, and i tones.

In some examples, a=7, b=9, and c=11, and d=2, e=3, f=4, g=5, h=6, and i=7.

In some examples, the second subset of RUs include a third RU having z tones.

In some examples, z=106.

In some examples, the bandwidth be 40 MHZ, the first subset of RUs including a first RU having x tones, a second RU having y tones, and a third RU having z tones.

In some examples, the first RU have x tones is associated at least with a first set of different tone spacings, the second RU having y tones is associated at least with a second set of different tone spacings, and the third RU having z tones is associated at least with a third set of different tone spacings.

In some examples, x=26, and the first set of different tone spacings include tone spacings of a tones, b tones, and c tones, y=52, and the second set of different tone spacings includes tone spacings of d tones, e tones, and f tones, and z=106, and the third set of different tone spacings includes tone spacings of g tones, h tones, i tones, j tones, k tones, and I tones.

In some examples, a=16, b=18, and c=20, d=7, e=9, and f=11, and g=2, h=3, i=4, j=5, k=6, and 1=7.

In some examples, the second subset of RUs include a fourth RU having w tones.

In some examples, w=242.

In some examples, the bandwidth be 80 MHz, the first subset of RUs including a first RU having x tones, and a second RU having y tones.

In some examples, the first RU have x tones is associated at least with a first set of different tone spacings, and the second RU having y tones is associated at least with a second set of different tone spacings.

In some examples, x=52, and the first set of different tone spacings include tone spacings of a tones, b tones, c tones, d tones, e tones, and f tones, and y=106, and the second set of different tone spacings includes tone spacings of g tones, h tones, i tones, j tones, and k tones.

In some examples, a=10, b=14, c=16, d=20, e=22, and f=26, and g=2, h=6, i=8, j=14, and k=18.

In some examples, the second subset of RUs include a third RU having z tones and includes a fourth RU having w tones.

In some examples, z=242, and w=484.

FIG. 12 shows a flowchart illustrating an example process 1200 performable by or at a wireless node that supports reducing OOBE for transmissions associated with a dRU allocation. The operations of the process 1200 may be implemented by a wireless node or its components as described herein. For example, the process 1200 may be performed by a wireless communication device, such as the wireless communication device 1100 described with reference to FIG. 11, operating as or within a wireless AP or a wireless STA. In some examples, the process 1200 may be performed by a wireless AP or a wireless STA, such as one of the APs 102 or the STAs 104 described with reference to FIG. 1.

In some examples, in block 1205, the wireless node may obtain an indication of an RU and an indication of a bandwidth, where a first subset of RUs associated with the bandwidth includes the indicated RU, the bandwidth being associated with the first subset and a second subset of RUs, where each of the RUs of the first subset includes a quantity of tones that is smaller than a quantity of tones of each of the RUs of the second subset, and where the indicated RU includes at least a first tone spacing between a first pair of consecutively populated tones, a second tone spacing between a second pair of consecutively populated tones, and a third tone spacing between a third pair of consecutively populated tones. The operations of block 1205 may be performed in accordance with examples as disclosed herein. In some implementations, aspects of the operations of block 1205 may be performed by a dRU indication component 1125 as described with reference to FIG. 11.

In some examples, in block 1210, the wireless node may output a frame for transmission via the bandwidth and in accordance with the indicated RU. The operations of block 1210 may be performed in accordance with examples as disclosed herein. In some implementations, aspects of the operations of block 1210 may be performed by a dRU transmission component 1130 as described with reference to FIG. 11.

FIG. 13 shows a flowchart illustrating an example process 1300 performable by or at a wireless node that supports reducing OOBE for transmissions associated with a dRU allocation. The operations of the process 1300 may be implemented by a wireless node or its components as described herein. For example, the process 1300 may be performed by a wireless communication device, such as the wireless communication device 1100 described with reference to FIG. 11, operating as or within a wireless AP or a wireless STA. In some examples, the process 1300 may be performed by a wireless AP or a wireless STA, such as one of the APs 102 or the STAs 104 described with reference to FIG. 1.

In some examples, in block 1305, the wireless node may output, for transmission, an indication of an RU and an indication of a bandwidth, where a first subset of RUs associated with the bandwidth includes the indicated RU, the bandwidth being associated with the first subset and a second subset of RUs, where each of the RUs of the first subset includes a quantity of tones that is smaller than a quantity of tones of each of the RUs of the second subset, and where the indicated RU includes at least a first tone spacing between a first pair of consecutively populated tones, a second tone spacing between a second pair of consecutively populated tones, and a third tone spacing between a third pair of consecutively populated tones. The operations of block 1305 may be performed in accordance with examples as disclosed herein. In some implementations, aspects of the operations of block 1305 may be performed by a dRU indication component 1125 as described with reference to FIG. 11.

In some examples, in block 1310, the wireless node may obtain a frame via the bandwidth and in accordance with the indicated RU. The operations of block 1310 may be performed in accordance with examples as disclosed herein. In some implementations, aspects of the operations of block 1310 may be performed by a dRU reception component 1135 as described with reference to FIG. 11.

Implementation examples are described in the following numbered clauses:

Clause 1: A method for wireless communication at a wireless node, comprising: obtaining an indication of an RU and an indication of a bandwidth, wherein a first subset of RUs associated with the bandwidth comprises the indicated RU, the bandwidth being associated with the first subset and a second subset of RUs, wherein each of the RUs of the first subset includes a quantity of tones that is smaller than a quantity of tones of each of the RUs of the second subset, and wherein the indicated RU comprises at least a first tone spacing between a first pair of consecutively populated tones, a second tone spacing between a second pair of consecutively populated tones, and a third tone spacing between a third pair of consecutively populated tones, and outputting a frame for transmission via the bandwidth and in accordance with the indicated RU.

Clause 2: The method of clause 1, further comprising: obtaining a trigger frame soliciting the frame, wherein the trigger frame includes the indication of the RU and the indication of the bandwidth, and wherein the frame is output after obtaining the trigger frame.

Clause 3: The method of any of clauses 1-2, further comprising: setting a power backoff parameter to a value in accordance with the indicated RU, wherein the frame is output for transmission based on the power backoff parameter.

Clause 4: The method of any of clauses 1-3, wherein a set of RUs associated with the bandwidth comprises the first subset of RUs and the second subset of RUs.

Clause 5: The method of clause 1-4, further comprising: refraining, for a time period, from applying a channel smoothing scheme for each resource unit of the first subset of RUs.

Clause 6: The method of any of clauses 1-5, wherein the RUs of the first subset are associated with at least a first quantity of tone spacings and the RUs of the second subset are associated with at most a second quantity of tone spacings, the first quantity of unique tone spacings being greater than or equal to the second quantity of unique tone spacings.

Clause 7: The method of any of clauses 1-6, wherein the first subset of RUs comprises at least two RUs, the at least two RUs including a first RU having a first quantity of tones and a second RU having a second quantity of tones that is greater than the first quantity of tones.

Clause 8: The method of clause 7, wherein the first RU having the first quantity of tones is associated with a first set of three or more different tone spacings, and the second RU having the second quantity of tones is associated with a second set of three or more different tone spacings.

Clause 9: The method of any of clauses 1-8, wherein the indicated RU comprises at least a first RU and a second RU.

Clause 10: The method of any of clauses 1-9, further comprising: switching one or more first tones of the indicated RU with one or more second tones of a second RU in accordance with a switch vector, each of the indicated RU and the second RU having a same quantity of tones and the second RU being included in the first subset of RUs, wherein the first tone spacing, the second tone spacing, and the third tone spacing are associated with the switch vector.

Clause 11: The method of clause 10, wherein the switch vector indicates a restriction against switching of tones that correspond to a subset of tone indices.

Clause 12: The method of any of clauses 10, wherein the switch vector indicates an allowance of switching of tones that correspond to a set of pilot tone indices.

Clause 13: The method of any of clauses 10, wherein an LTF sequence corresponding to the indicated RU is associated with the first tone spacing, the second tone spacing, and the third tone spacing.

Clause 14: The method of any of clauses 10, wherein the switch vector is based on a target PAPR associated with an LTF sequence corresponding to the indicated RU.

Clause 15: The method of any of clauses 1-14, wherein the bandwidth is 20 MHz, the first subset of RUs including a first RU having x tones, and a second RU having y tones.

Clause 16: The method of clause 15, wherein the first RU having x tones is associated at least with a first set of different tone spacings, and the second RU having y tones is associated at least with a second set of different tone spacings.

Clause 17: The method of clause 16, wherein x=26, and the first set of different tone spacings includes tone spacings of a tones, b tones, and c tones, and y=52, and the second set of different tone spacings includes tone spacings of d tones, e tones, f tones, g tones, h tones, and i tones.

Clause 18: The method of clause 17, wherein a=7, b=9, and c=11, and d=2, e=3, f=4, g=5, h=6, and i=7.

Clause 19: The method of any of clauses 15, wherein the second subset of RUs includes a third RU having z tones.

Clause 20: The method of clause 19, wherein z=106.

Clause 21: The method of any of clauses 1-14, wherein the bandwidth is 40 MHz, the first subset of RUs including a first RU having x tones, a second RU having y tones, and a third RU having z tones.

Clause 22: The method of clause 21, wherein the first RU having x tones is associated at least with a first set of different tone spacings, the second RU having y tones is associated at least with a second set of different tone spacings, and the third RU having z tones is associated at least with a third set of different tone spacings.

Clause 23: The method of clause 22, wherein x=26, and the first set of different tone spacings includes tone spacings of a tones, b tones, and c tones, y=52, and the second set of different tone spacings includes tone spacings of d tones, e tones, and f tones, and z=106, and the third set of different tone spacings includes tone spacings of g tones, h tones, i tones, j tones, k tones, and 1 tones.

Clause 24: The method of clause 23, wherein a=16, b=18, and c=20, d=7, e=9, and f=11, and g=2, h=3, i=4, j=5, k=6, and 1=7.

Clause 25: The method of any of clauses 21, wherein the second subset of RUs includes a fourth RU having w tones.

Clause 26: The method of clause 25, wherein w=242.

Clause 27: The method of any of clauses 1-14, wherein the bandwidth is 80 MHz, the first subset of RUs including a first RU having x tones, and a second RU having y tones.

Clause 28: The method of clause 27, wherein the first RU having x tones is associated at least with a first set of different tone spacings, and the second RU having y tones is associated at least with a second set of different tone spacings.

Clause 29: The method of clause 28, wherein x=52, and the first set of different tone spacings includes tone spacings of a tones, b tones, c tones, d tones, e tones, and f tones, and y=106, and the second set of different tone spacings includes tone spacings of g tones, h tones, i tones, j tones, and k tones.

Clause 30: The method of clause 29, wherein a=10, b=14, c=16, d=20, e=22, and f=26, and g=2, h=6, i=8, j=14, and k=18.

Clause 31: The method of any of clauses 27, wherein the second subset of RUs includes a third RU having z tones and includes a fourth RU having w tones.

Clause 32: The method of clause 31, wherein z=242, and w=484.

Clause 33: A method for wireless communication at a wireless node, comprising: outputting, for transmission, an indication of an RU and an indication of a bandwidth, wherein a first subset of RUs associated with the bandwidth comprises the indicated RU, the bandwidth being associated with the first subset and a second subset of RUs, wherein each of the RUs of the first subset includes a quantity of tones that is smaller than a quantity of tones of each of the RUs of the second subset, and wherein the indicated RU comprises at least a first tone spacing between a first pair of consecutively populated tones, a second tone spacing between a second pair of consecutively populated tones, and a third tone spacing between a third pair of consecutively populated tones, and obtaining a frame via the bandwidth and in accordance with the indicated RU.

Clause 34: The method of clause 33, further comprising: outputting, for transmission, a trigger frame soliciting the frame, wherein the trigger frame includes the indication of the RU and the indication of the bandwidth, and wherein the frame is obtained after outputting the trigger frame.

Clause 35: The method of any of clauses 33-34, wherein a set of RUs associated with the bandwidth comprises the first subset of RUs and the second subset of RUs.

Clause 36: The method of clause 33-35, further comprising: refraining, for a time period, from applying a channel smoothing scheme for each resource unit of the first subset of RUs.

Clause 37: The method of any of clauses 33-36, wherein the RUs of the first subset are associated with at least a first quantity of tone spacings and the RUs of the second subset are associated with at most a second quantity of unique tone spacings, the first quantity of tone spacings being greater than or equal to the second quantity of unique tone spacings.

Clause 38: The method of any of clauses 33-37, wherein the subset of RUs comprises at least two RUs, the at least two RUs including a first RU having a first quantity of tones, and a second RU having a second quantity of tones that is greater than the first quantity of tones.

Clause 39: The method of clause 38, wherein the first RU having the first quantity of tones is associated with a first set of three or more different tone spacings, and the second RU having the second quantity of tones is associated with a second set of three or more different tone spacings.

Clause 40: The method of any of clauses 33-39, wherein the indicated RU comprises at least a first RU and a second RU.

Clause 41: The method of any of clauses 33-40, further comprising: switching one or more first tones of the indicated RU with one or more second tones of a second RU in accordance with a switch vector, each of the indicated RU and the second RU having a same quantity of tones and the second RU being included in the first subset of RUs, wherein the first tone spacing, the second tone spacing, and the third tone spacing are associated with the switch vector.

Clause 42: The method of clause 41, wherein the switch vector indicates a restriction against switching of tones that correspond to a subset of tone indices.

Clause 43: The method of any of clauses 41, wherein the switch vector indicates an allowance of switching of tones that correspond to a set of pilot tone indices.

Clause 44: The method of any of clauses 41, wherein an LTF sequence corresponding to the indicated RU is associated with the first tone spacing, the second tone spacing, and the third tone spacing.

Clause 45: The method of any of clauses 41, wherein the switch vector is based on a target PAPR associated with an LTF sequence corresponding to the indicated RU.

Clause 46: The method of any of clauses 33-45, wherein the bandwidth is 20 MHz, the first subset of RUs including a first RU having x tones, and a second RU having y tones.

Clause 47: The method of clause 46, wherein the first RU having x tones is associated at least with a first set of different tone spacings, and the second RU having y tones is associated at least with a second set of different tone spacings.

Clause 48: The method of clause 47, wherein x=26, and the first set of different tone spacings includes tone spacings of a tones, b tones, and c tones, and y=52, and the second set of different tone spacings includes tone spacings of d tones, e tones, f tones, g tones, h tones, and i tones.

Clause 49: The method of clause 48, wherein a=7, b=9, and c=11, and d=2, e=3, f=4, g=5, h=6, and i=7.

Clause 50: The method of any of clauses 46, wherein the second subset of RUs includes a third RU having z tones.

Clause 51: The method of clause 50, wherein z=106.

Clause 52: The method of any of clauses 33-45, wherein the bandwidth is 40 MHz, the first subset of RUs including a first RU having x tones, a second RU having y tones, and a third RU having z tones.

Clause 53: The method of clause 52, wherein the first RU having x tones is associated at least with a first set of different tone spacings, the second RU having y tones is associated at least with a second set of different tone spacings, and the third RU having z tones is associated at least with a third set of different tone spacings.

Clause 54: The method of clause 53, wherein x=26, and the first set of different tone spacings includes tone spacings of a tones, b tones, and c tones, y=52, and the second set of different tone spacings includes tone spacings of d tones, e tones, and f tones, and z=106, and the third set of different tone spacings includes tone spacings of g tones, h tones, i tones, j tones, k tones, and 1 tones.

Clause 55: The method of clause 54, wherein a=16, b=18, and c=20, d=7, e=9, and f=11, and g=2, h=3, i=4, j=5, k=6, and 1=7.

Clause 56: The method of any of clauses 52, wherein the second subset of RUs includes a fourth RU having w tones.

Clause 57: The method of clause 56, wherein w=242.

Clause 58: The method of any of clauses 33, wherein the bandwidth is 80 MHz, the first subset of RUs including a first RU having x tones, and a second RU having y tones.

Clause 59: The method of clause 58, wherein the first RU having x tones is associated at least with a first set of different tone spacings, and the second RU having y tones is associated at least with a second set of different tone spacings.

Clause 60: The method of clause 59, wherein x=52, and the first set of different tone spacings includes tone spacings of a tones, b tones, c tones, d tones, e tones, and f tones, and y=106, and the second set of different tone spacings includes tone spacings of g tones, h tones, i tones, j tones, and k tones.

Clause 61: The method of clause 60, wherein a=10, b=14, c=16, d=20, e=22, and f=26, and g=2, h=6, i=8, j=14, and k=18.

Clause 62: The method of any of clauses 58, wherein the second subset of RUs includes a third RU having z tones and includes a fourth RU having w tones.

Clause 63: The method of clause 62, wherein z=242, and w=484.

Clause 64: An apparatus for wireless communication, comprising a processing system that includes processor circuitry and memory circuitry that stores code, the processing system configured to cause the apparatus to perform a method of any of clauses 1-32.

Clause 65: An apparatus for wireless communication, comprising at least one means for performing a method of any of clauses 1-32 using a processing system, one or more processors, or circuitry.

Clause 66: A non-transitory computer-readable medium storing code for wireless communication, the code comprising instructions executable by one or more processors, individually or collectively, to perform a method of any of clauses 1-32.

Clause 67: A wireless STA, comprising at least one transceiver, at least one memory comprising executable instructions, and one or more processors configured to execute the executable instructions and cause the wireless STA to perform a method of any of clauses 1-32, wherein the at least one transceiver is configured to receive the indication of the RU and the indication of the bandwidth, and wherein the at least one transceiver is configured to transmit the frame via the bandwidth and in accordance with the indicated RU.

Clause 68: A wireless STA, comprising at least one means for performing a method of any of clauses 1-32 using a processing system, one or more processors, or circuitry.

Clause 69: An apparatus for wireless communication, comprising a processing system that includes processor circuitry and memory circuitry that stores code, the processing system configured to cause the apparatus to perform a method of any of clauses 33-63.

Clause 70: An apparatus for wireless communication, comprising at least one means for performing a method of any of clauses 33-63 using a processing system, one or more processors, or circuitry.

Clause 71: A non-transitory computer-readable medium storing code for wireless communication, the code comprising instructions executable by one or more processors, individually or collectively, to perform a method of any of clauses 33-63.

Clause 72: A wireless AP, comprising at least one transceiver, at least one memory comprising executable instructions, and one or more processors configured to execute the executable instructions and cause the wireless AP to perform a method of any of clauses 33-63, wherein the at least one transceiver is configured to transmit the indication of the RU and the indication of the bandwidth, and wherein the at least one transceiver is configured to receive the frame via the bandwidth and in accordance with the indicated RU.

Clause 73: A wireless AP, comprising at least one means for performing a method of any of clauses 33-63 using a processing system, one or more processors, or circuitry.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. In other words, as used herein, including in the claims, “or” as used in a list of items (such as a list of items prefaced by a phrase such as “at least one of” or “one or more of”) indicates a disjunctive list such that, for example, a list of “at least one of A, B, or C” means A or B or C or AA or AB or AC or BC or ABC (A and B and C). Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus for wireless communication, comprising:
a processing system that includes processor circuitry and memory circuitry that stores code, the processing system configured to cause the apparatus to:
obtain an indication of a resource unit and an indication of a bandwidth, wherein a first subset of resource units associated with the bandwidth comprises the indicated resource unit, the bandwidth being associated with the first subset and a second subset of resource units, wherein each of the resource units of the first subset includes a quantity of tones that is smaller than a quantity of tones of each of the resource units of the second subset, and wherein the indicated resource unit comprises at least a first tone spacing between a first pair of consecutively populated tones, a second tone spacing between a second pair of consecutively populated tones, and a third tone spacing between a third pair of consecutively populated tones; and
output a frame for transmission via the bandwidth and in accordance with the indicated resource unit.

2. The apparatus of claim 1, wherein the processing system is further configured to cause the apparatus to:
obtain a trigger frame soliciting the frame, wherein the trigger frame includes the indication of the resource unit and the indication of the bandwidth, and wherein the frame is output for transmission after obtaining the trigger frame.

3. The apparatus of claim 1, wherein the processing system is further configured to cause the apparatus to:
set a power backoff parameter to a value in accordance with the indicated resource unit, wherein the frame is output for transmission based on the power backoff parameter.

4. The apparatus of claim 1, wherein the processing system is configured to cause the apparatus to:
refrain, for a time period, from applying a channel smoothing scheme for each resource unit of the first subset of resource units.

5. The apparatus of claim 1, wherein the resource units of the first subset are associated with at least a first quantity of tone spacings and the resource units of the second subset are associated with at most a second quantity of tone spacings, the first quantity of tone spacings being greater than or equal to the second quantity of tone spacings.

6. The apparatus of claim 1, wherein the first subset of resource units comprises at least two resource units, the at least two resource units including:
a first resource unit having a first quantity of tones; and
a second resource unit having a second quantity of tones that is greater than the first quantity of tones.

7. The apparatus of claim 6, wherein:
the first resource unit having the first quantity of tones is associated with a first set of three or more different tone spacings; and
the second resource unit having the second quantity of tones is associated with a second set of three or more different tone spacings.

8. The apparatus of claim 1, wherein the processing system is further configured to cause the apparatus to:
switch one or more first tones of the indicated resource unit with one or more second tones of a second resource unit in accordance with a switch vector, each of the indicated resource unit and the second resource unit having a same quantity of tones and the second resource unit being included in the first subset of resource units, wherein the first tone spacing, the second tone spacing, and the third tone spacing are associated with the switch vector.

9. The apparatus of claim 8, wherein the switch vector indicates a restriction against switching of tones that correspond to a subset of tone indices.

10. The apparatus of claim 8, wherein the switch vector indicates an allowance of switching of tones that correspond to a set of pilot tone indices.

11. The apparatus of claim 8, wherein a long training field (LTF) sequence corresponding to the indicated resource unit is associated with the first tone spacing, the second tone spacing, and the third tone spacing.

12. The apparatus of claim 8, wherein the switch vector is based on a target peak-to-average power ratio (PAPR) associated with a long training field (LTF) sequence corresponding to the indicated resource unit.

13. The apparatus of claim 1, wherein the bandwidth is 20 megahertz (MHz), the first subset of resource units including:
a first resource unit having x tones; and
a second resource unit having y tones.

14. The apparatus of claim 13, wherein:
the first resource unit having x tones is associated at least with a first set of different tone spacings; and
the second resource unit having y tones is associated at least with a second set of different tone spacings.

15. The apparatus of claim 14, wherein:
x=26, and the first set of different tone spacings includes tone spacings of a tones, b tones, and c tones; and
y=52, and the second set of different tone spacings includes tone spacings of d tones, e tones, f tones, g tones, h tones, and i tones.

16. The apparatus of claim 1, wherein the bandwidth is 40 megahertz (MHz), the first subset of resource units including:
a first resource unit having x tones;
a second resource unit having y tones; and
a third resource unit having z tones.

17. The apparatus of claim 16, wherein:
the first resource unit having x tones is associated at least with a first set of different tone spacings;
the second resource unit having y tones is associated at least with a second set of different tone spacings; and
the third resource unit having z tones is associated at least with a third set of different tone spacings.

18. The apparatus of claim 17, wherein:
x=26, and the first set of different tone spacings includes tone spacings of a tones, b tones, and c tones;
y=52, and the second set of different tone spacings includes tone spacings of d tones, e tones, and f tones; and
z=106, and the third set of different tone spacings includes tone spacings of g tones, h tones, i tones, j tones, k tones, and 1 tones.

19. The apparatus of claim 1, wherein the bandwidth is 80 megahertz (MHz), the first subset of resource units including:
a first resource unit having x tones; and
a second resource unit having y tones.

20. The apparatus of claim 19, wherein:
the first resource unit having x tones is associated at least with a first set of different tone spacings; and
the second resource unit having y tones is associated at least with a second set of different tone spacings.

21. The apparatus of claim 20, wherein:
x=52, and the first set of different tone spacings includes tone spacings of a tones, b tones, c tones, d tones, e tones, and f tones; and
y=106, and the second set of different tone spacings includes tone spacings of g tones, h tones, i tones, j tones, and k tones.

22. The apparatus of claim 1, further comprising a transceiver configured to:
receive the indication of the resource unit and the indication of the bandwidth; and
transmit the frame via the bandwidth and in accordance with the indicated resource unit, wherein:
the apparatus is configured as a wireless station (STA).

23. An apparatus for wireless communication, comprising:
a processing system that includes processor circuitry and memory circuitry that stores code, the processing system configured to cause the apparatus to:
output, for transmission, an indication of a resource unit and an indication of a bandwidth, wherein a first subset of resource units associated with the bandwidth comprises the indicated resource unit, the bandwidth being associated with the first subset and a second subset of resource units, wherein each of the resource units of the first subset includes a quantity of tones that is smaller than a quantity of tones of each of the resource units of the second subset, and wherein the indicated resource unit comprises at least a first tone spacing between a first pair of consecutively distributed tones, a second tone spacing between a second pair of consecutively distributed tones, and a third tone spacing between a third pair of consecutively distributed tones; and
obtain a frame via the bandwidth and in accordance with the indicated resource unit.

24. The apparatus of claim 23, wherein the processing system is configured to cause the apparatus to:
refrain, for a time period, from applying a channel smoothing scheme for each resource unit of the first subset of resource units.

25. The apparatus of claim 23, wherein the resource units of the first subset are associated with at least a first quantity of tone spacings and the resource units of the second subset are associated with at most a second quantity of tone spacings, the first quantity of tone spacings being greater than or equal to the second quantity of tone spacings.

26. The apparatus of claim 23, wherein the subset of resource units comprises at least two resource units, the at least two resource units including:
a first resource unit having a first quantity of tones; and
a second resource unit having a second quantity of tones that is greater than the first quantity of tones.

27. The apparatus of claim 26, wherein:
the first resource unit having the first quantity of tones is associated with a first set of three or more different tone spacings; and
the second resource unit having the second quantity of tones is associated with a second set of three or more different tone spacings.

28. The apparatus of claim 23, further comprising a transceiver configured to:
transmit the indication of the resource unit and the indication of the bandwidth; and
receive the frame via the bandwidth and in accordance with the indicated resource unit, wherein:
the apparatus is configured as a wireless access point (AP).

29. A method for wireless communication at a wireless node, comprising:
obtaining an indication of a resource unit and an indication of a bandwidth, wherein a first subset of resource units associated with the bandwidth comprises the indicated resource unit, the bandwidth being associated with the first subset and a second subset of resource units, wherein each of the resource units of the first subset includes a quantity of tones that is smaller than a quantity of tones of each of the resource units of the second subset, and wherein the indicated resource unit comprises at least a first tone spacing between a first pair of consecutively distributed tones, a second tone spacing between a second pair of consecutively distributed tones, and a third tone spacing between a third pair of consecutively distributed tones; and
outputting a frame for transmission via the bandwidth and in accordance with the indicated resource unit.

30. A method for wireless communication at a wireless node, comprising:
outputting, for transmission, an indication of a resource unit and an indication of a bandwidth, wherein a first subset of resource units associated with the bandwidth comprises the indicated resource unit, the bandwidth being associated with the first subset and a second subset of resource units, wherein each of the resource units of the first subset includes a quantity of tones that is smaller than a quantity of tones of each of the resource units of the second subset, and wherein the indicated resource unit comprises at least a first tone spacing between a first pair of consecutively distributed tones, a second tone spacing between a second pair of consecutively distributed tones, and a third tone spacing between a third pair of consecutively distributed tones; and
obtaining a frame via the bandwidth and in accordance with the indicated resource unit.
